(19) United States
(12) Patent Application Publication
(10) Pub. No.: US 2017/0231002 A1
(43) Pub. Date: Aug. 10, 2017

(54) RANDOM ACCESS PROCEDURE IN A WIRELESS NETWORK

(71) Applicant: Ofinno Technologies, LLC, Herndon, VA (US)

(72) Inventors: Alireza Babaei, Asburn, VA (US); Esmael Hejazi Dinan, Herndon, VA (US)

(73) Assignee: Ofinno Technologies, LLC, Herndon, VA (US)

(21) Appl. No.: 15/425,686

(22) Filed: Feb. 6, 2017

Related U.S. Application Data
(60) Provisional application No. 62/291,374, filed on Feb. 4, 2016.
(60) Provisional application No. 62/291,395, filed on Feb. 4, 2016.

(51) Int. Cl. H04W 74/08; H04W 24/08; H04L 5/00; H04W 72/04

(52) U.S. Cl. CPC H04W 74/085; H04W 72/042; H04W 24/08; H04L 5/0007

(57) ABSTRACT

A wireless device receives one or more messages comprising configuration parameters of a licensed assisted access (LAA) cell. The wireless device receives a physical downlink control channel (PDCCH) order initiating a random access procedure on the LAA cell. The wireless device performs a listen before talk (LBT) procedure to attempt to transmit a random access preamble on the LAA cell. The wireless device increments a counter after a transmission attempt. The wireless device considers the random access procedure unsuccessful on the LAA cell when the counter reaches a first value.

### CROSS-REFERENCE TO RELATED APPLICATIONS

This application claims the benefit of U.S. Provisional Application No. 62/291,374, filed Feb. 4, 2016, and U.S. Provisional Application No. 62/291,395, filed Feb. 4, 2016 which are hereby incorporated by reference in their entirety.

### BRIEF DESCRIPTION OF THE SEVERAL VIEWS OF THE DRAWINGS

Examples of several of the various embodiments of the present disclosure are described herein with reference to the drawings.

FIG. 1 is a diagram depicting example sets of OFDM subcarriers as per an aspect of an embodiment of the present disclosure.

FIG. 2 is a diagram depicting an example transmission time and reception time for two carriers in a carrier group as per an aspect of an embodiment of the present disclosure.

FIG. 3 is an example diagram depicting OFDM radio resources as per an aspect of an embodiment of the present disclosure.

FIG. 4 is an example block diagram of a base station and a wireless device as per an aspect of an embodiment of the present disclosure.

FIG. 5A, FIG. 5B, FIG. 5C and FIG. 5D are example diagrams for uplink and downlink signal transmission as per an aspect of an embodiment of the present disclosure.

FIG. 6 is an example diagram for a protocol structure with CA and DC as per an aspect of an embodiment of the present disclosure.

FIG. 7 is an example diagram for a protocol structure with CA and DC as per an aspect of an embodiment of the present disclosure.

FIG. 8 shows example TAG configurations as per an aspect of an embodiment of the present disclosure.

FIG. 9 is an example message flow in a random access process in a secondary TAG as per an aspect of an embodiment of the present disclosure.

FIG. 10 is an example diagram depicting a downlink burst as per an aspect of an embodiment of the present disclosure.

FIG. 11 is an example subframe configuration as per an aspect of an embodiment of the present disclosure.

FIG. 12 is an example diagram depicting various signal transmissions as per an aspect of an embodiment of the present disclosure.

FIG. 13 is an example diagram depicting various signal transmissions as per an aspect of an embodiment of the present disclosure.

FIG. 14 is an example diagram depicting various signal transmissions as per an aspect of an embodiment of the present disclosure.

FIG. 15 is an example diagram depicting various signal transmissions as per an aspect of an embodiment of the present disclosure.

FIG. 16 is an example diagram depicting various signal transmissions as per an aspect of an embodiment of the present disclosure.

FIG. 17 is an example diagram depicting various signal transmissions as per an aspect of an embodiment of the present disclosure.

FIG. 18 is an example diagram depicting various signal transmissions as per an aspect of an embodiment of the present disclosure.

FIG. 19 is an example diagram depicting various signal transmissions as per an aspect of an embodiment of the present disclosure.

FIG. 20 is an example diagram illustrating a random access procedure as per an aspect of an embodiment of the present disclosure.

FIG. 21 is an example diagram illustrating a random access procedure as per an aspect of an embodiment of the present disclosure.

FIG. 22 is an example timing advance value as per an aspect of an embodiment of the present disclosure.

FIG. 23 is an example flow diagram as per an aspect of an embodiment of the present disclosure.

FIG. 24 is an example flow diagram as per an aspect of an embodiment of the present disclosure.

FIG. 25 is an example flow diagram as per an aspect of an embodiment of the present disclosure.

FIG. 26 is an example flow diagram as per an aspect of an embodiment of the present disclosure.

FIG. 27 is an example flow diagram as per an aspect of an embodiment of the present disclosure.

### DETAILED DESCRIPTION OF EMBODIMENTS

Example embodiments of the present disclosure enable operation of carrier aggregation. Embodiments of the technology disclosed herein may be employed in the technical field of multicarrier communication systems.

The following Acronyms are used throughout the present disclosure:
ASIC application-specific integrated circuit
BPSK binary phase shift keying
CA carrier aggregation
CSI channel state information
CDMA code division multiple access
CSS common search space
CPLD complex programmable logic devices
CC component carrier
DL downlink
DCI downlink control information
DC dual connectivity
EPC evolved packet core
E-UTRAN evolved-universal terrestrial radio access network
FPGA field programmable gate arrays
FDD frequency division multiplexing
HDL hardware description languages
HARQ hybrid automatic repeat request
IE information element
LAA licensed assisted access
LTE long term evolution
MCG master cell group
MeNB master evolved node B
MIB master information block
MAC media access control
MME mobility management entity
NAS non-access stratum
OFDM orthogonal frequency division multiplexing
PDCP packet data convergence protocol
PDU packet data unit
PHY physical
PDCCH physical downlink control channel
PHICH physical HARQ indicator channel
PUCCH physical uplink control channel
PUSCH physical uplink shared channel
PCell primary cell
PCC primary component carrier
PSCell primary secondary cell
pTAG primary timing advance group
QAM quadrature amplitude modulation
QPSK quadrature phase shift keying
RBG Resource Block Groups
RLC radio link control
RRC radio resource control
RA random access
RB resource blocks
SCC secondary component carrier
SCell secondary cell
Scell secondary cells
SCG secondary cell group
SeNB secondary evolved node B
sTAGs secondary timing advance group
SDU service data unit
S-GW serving gateway
SRB signaling radio bearer
SC-OFDM single carrier-OFDM
SFN system frame number
SIB system information block
TAI tracking area identifier
TAT time alignment timer
TDD time division duplexing
TDMA time division multiple access
TA timing advance
TAG timing advance group
TB transport block
UL uplink
UE user equipment
VHDL VHSIC hardware description language

Example embodiments of the disclosure may be implemented using various physical layer modulation and transmission mechanisms. Example transmission mechanisms may include, but are not limited to: CDMA, OFDM, TDMA, Wavelet technologies, and/or the like. Hybrid transmission mechanisms such as TDMA/CDMA, and OFDM/CDMA may also be employed. Various modulation schemes may be applied for signal transmission in the physical layer. Examples of modulation schemes include, but are not limited to: phase, amplitude, code, a combination of these, and/or the like. An example radio transmission method may implement QAM using BPSK, QPSK, 16-QAM, 64-QAM, 256-QAM, and/or the like. Physical radio transmission may be enhanced by dynamically or semi-dynamically changing the modulation and coding scheme depending on transmission requirements and radio conditions.

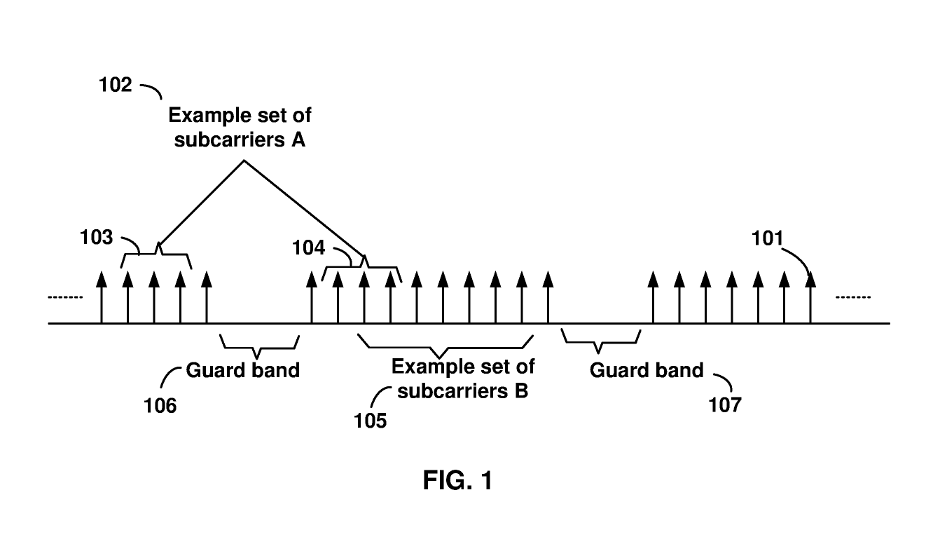

FIG. 1 is a diagram depicting example sets of OFDM subcarriers as per an aspect of an embodiment of the present disclosure. As illustrated in this example, arrow(s) in the diagram may depict a subcarrier in a multicarrier OFDM system. The OFDM system may use technology such as OFDM technology, DFTS-OFDM, SC-OFDM technology, or the like. For example, arrow 101 shows a subcarrier transmitting information symbols. FIG. 1 is for illustration purposes, and a typical multicarrier OFDM system may include more subcarriers in a carrier. For example, the number of subcarriers in a carrier may be in the range of 10 to 10,000 subcarriers. FIG. 1 shows two guard bands 106 and 107 in a transmission band. As illustrated in FIG. 1, guard band 106 is between subcarriers 103 and subcarriers 104. The example set of subcarriers A 102 includes subcarriers 103 and subcarriers 104. FIG. 1 also illustrates an example set of subcarriers B 105. As illustrated, there is no guard band between any two subcarriers in the example set of subcarriers B 105. Carriers in a multicarrier OFDM communication system may be contiguous carriers, non-contiguous carriers, or a combination of both contiguous and non-contiguous carriers.

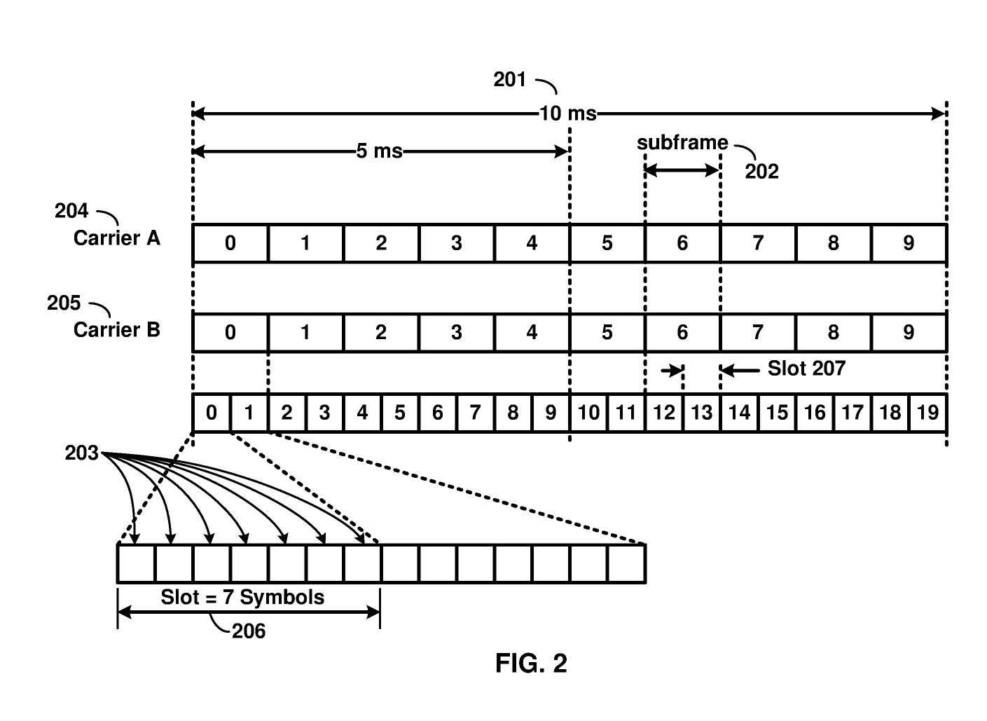

FIG. 2 is a diagram depicting an example transmission time and reception time for two carriers as per an aspect of an embodiment of the present disclosure. A multicarrier OFDM communication system may include one or more carriers, for example, ranging from 1 to 10 carriers. Carrier A 204 and carrier B 205 may have the same or different timing structures. Although FIG. 2 shows two synchronized carriers, carrier A 204 and carrier B 205 may or may not be synchronized with each other. Different radio frame structures may be supported for FDD and TDD duplex mechanisms. FIG. 2 shows an example FDD frame timing. Downlink and uplink transmissions may be organized into radio frames 201. In this example, the radio frame duration is 10 msec. Other frame durations, for example, in the range of 1 to 100 msec may also be supported. In this example, each 10 ms radio frame 201 may be divided into ten equally sized subframes 202. Other subframe durations such as 0.5 msec, 1 msec, 2 msec, and 5 msec may also be supported. Subframe(s) may consist of two or more slots (for example, slots 206 and 207). For the example of FDD, 10 subframes may be available for downlink transmission and 10 subframes may be available for uplink transmissions in each 10 ms interval. Uplink and downlink transmissions may be separated in the frequency domain. Slot(s) may include a plurality of OFDM symbols 203. The number of OFDM symbols 203 in a slot 206 may depend on the cyclic prefix length and subcarrier spacing.

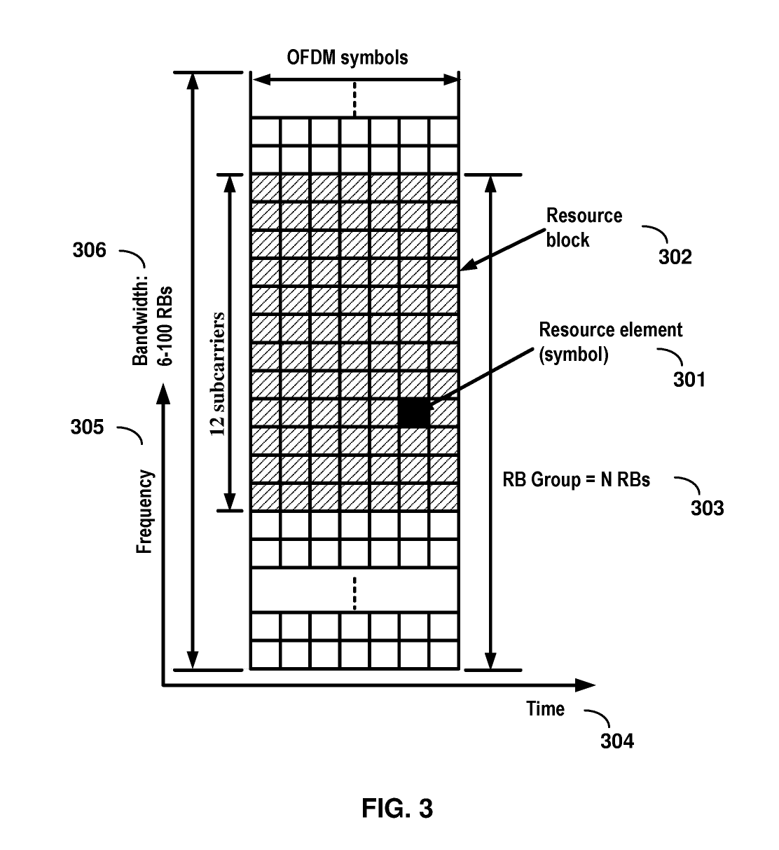

FIG. 3 is a diagram depicting OFDM radio resources as per an aspect of an embodiment of the present disclosure. The resource grid structure in time 304 and frequency 305 is illustrated in FIG. 3. The quantity of downlink subcarriers or RBs (in this example 6 to 100 RBs) may depend, at least in part, on the downlink transmission bandwidth 306 configured in the cell. The smallest radio resource unit may be called a resource element (e.g. 301). Resource elements may be grouped into resource blocks (e.g. 302). Resource blocks may be grouped into larger radio resources called Resource Block Groups (RBG) (e.g. 303). The transmitted signal in slot 206 may be described by one or several resource grids of a plurality of subcarriers and a plurality of OFDM symbols. Resource blocks may be used to describe the mapping of certain physical channels to resource elements. Other pre-defined groupings of physical resource elements may be implemented in the system depending on the radio technology. For example, 24 subcarriers may be grouped as a radio block for a duration of 5 msec. In an illustrative example, a resource block may correspond to one slot in the time domain and 180 kHz in the frequency domain (for 15 KHz subcarrier bandwidth and 12 subcarriers).

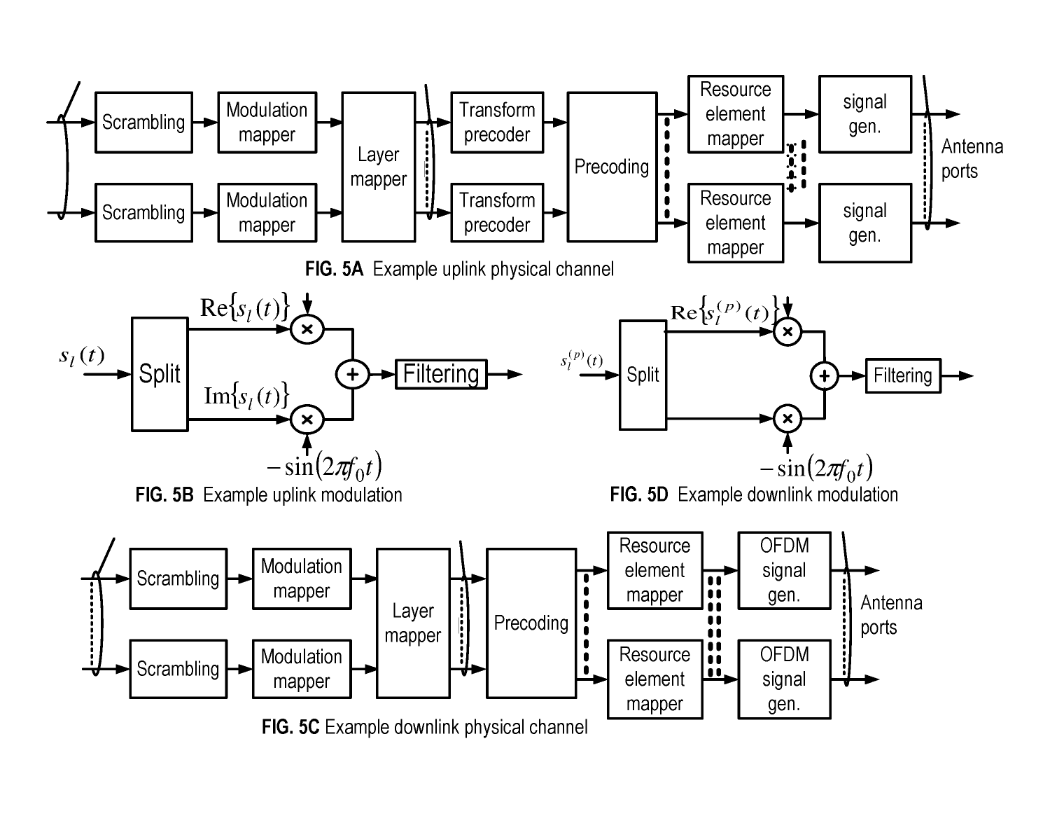

FIG. 5A, FIG. 5B, FIG. 5C and FIG. 5D are example diagrams for uplink and downlink signal transmission as per an aspect of an embodiment of the present disclosure. FIG. 5A shows an example uplink physical channel. The baseband signal representing the physical uplink shared channel may perform the following processes. These functions are illustrated as examples and it is anticipated that other mechanisms may be implemented in various embodiments. The functions may comprise scrambling, modulation of scrambled bits to generate complex-valued symbols, mapping of the complex-valued modulation symbols onto one or several transmission layers, transform precoding to generate complex-valued symbols, precoding of the complex-valued symbols, mapping of precoded complex-valued symbols to resource elements, generation of complex-valued time-domain DFTS-OFDM/SC-FDMA signal for each antenna port, and/or the like.

Example modulation and up-conversion to the carrier frequency of the complex-valued DFTS-OFDM/SC-FDMA baseband signal for each antenna port and/or the complex-valued PRACH baseband signal is shown in FIG. 5B. Filtering may be employed prior to transmission.

An example structure for Downlink Transmissions is shown in FIG. 5C. The baseband signal representing a downlink physical channel may perform the following processes. These functions are illustrated as examples and it is anticipated that other mechanisms may be implemented in various embodiments. The functions include scrambling of coded bits in each of the codewords to be transmitted on a physical channel; modulation of scrambled bits to generate complex-valued modulation symbols; mapping of the complex-valued modulation symbols onto one or several transmission layers; precoding of the complex-valued modulation symbols on each layer for transmission on the antenna ports; mapping of complex-valued modulation symbols for each antenna port to resource elements; generation of complex-valued time-domain OFDM signal for each antenna port, and/or the like.

Example modulation and up-conversion to the carrier frequency of the complex-valued OFDM baseband signal for each antenna port is shown in FIG. 5D. Filtering may be employed prior to transmission.

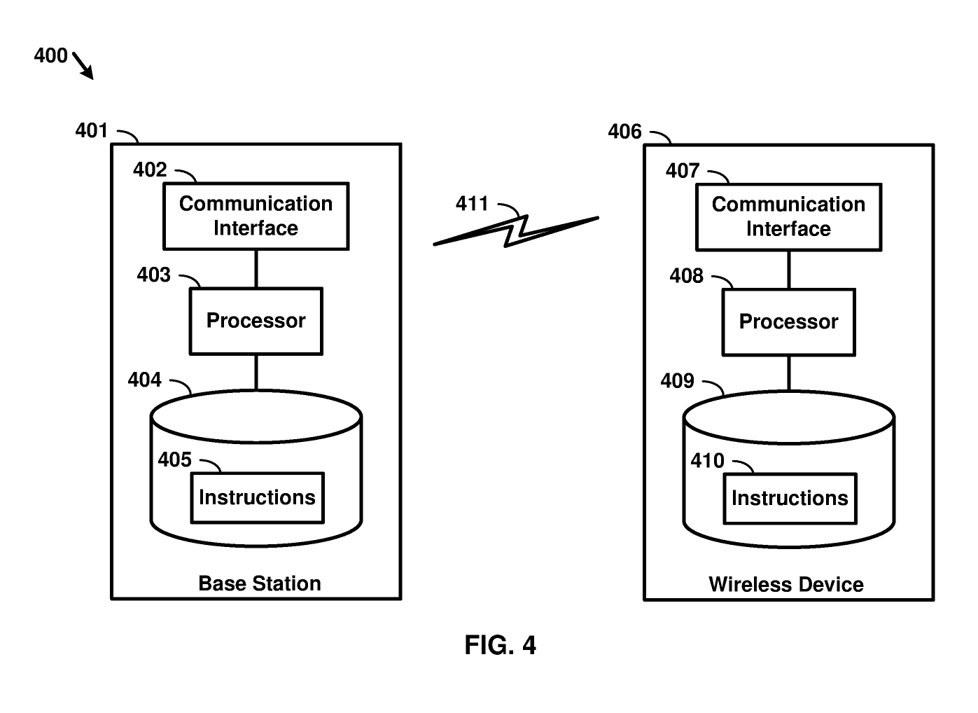

FIG. 4 is an example block diagram of a base station 401 and a wireless device 406, as per an aspect of an embodiment of the present disclosure. A communication network 400 may include at least one base station 401 and at least one wireless device 406. The base station 401 may include at least one communication interface 402, at least one processor 403, and at least one set of program code instructions 405 stored in non-transitory memory 404 and executable by the at least one processor 403. The wireless device 406 may include at least one communication interface 407, at least one processor 408, and at least one set of program code instructions 410 stored in non-transitory memory 409 and executable by the at least one processor 408. Communication interface 402 in base station 401 may be configured to engage in communication with communication interface 407 in wireless device 406 via a communication path that includes at least one wireless link 411. Wireless link 411 may be a bi-directional link. Communication interface 407 in wireless device 406 may also be configured to engage in a communication with communication interface 402 in base station 401. Base station 401 and wireless device 406 may be configured to send and receive data over wireless link 411 using multiple frequency carriers. According to aspects of an embodiments, transceiver(s) may be employed. A transceiver is a device that includes both a transmitter and receiver. Transceivers may be employed in devices such as wireless devices, base stations, relay nodes, and/or the like. Example embodiments for radio technology implemented in communication interface 402, 407 and wireless link 411 are illustrated are FIG. 1, FIG. 2, FIG. 3, FIG. 5, and associated text.

An interface may be a hardware interface, a firmware interface, a software interface, and/or a combination thereof. The hardware interface may include connectors, wires, electronic devices such as drivers, amplifiers, and/or the like. A software interface may include code stored in a memory device to implement protocol(s), protocol layers, communication drivers, device drivers, combinations thereof, and/or the like. A firmware interface may include a combination of embedded hardware and code stored in and/or in communication with a memory device to implement connections, electronic device operations, protocol(s), protocol layers, communication drivers, device drivers, hardware operations, combinations thereof, and/or the like.

The term configured may relate to the capacity of a device whether the device is in an operational or non-operational state. Configured may also refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics in the device, whether the device is in an operational or non-operational state.

According to various aspects of an embodiment, an LTE network may include a multitude of base stations, providing a user plane PDCP/RLC/MAC/PHY and control plane (RRC) protocol terminations towards the wireless device. The base station(s) may be interconnected with other base station(s) (for example, interconnected employing an X2 interface). Base stations may also be connected employing, for example, an S1 interface to an EPC. For example, base stations may be interconnected to the MME employing the S1-MME interface and to the S-G) employing the S1-U interface. The S1 interface may support a many-to-many relation between MMEs/Serving Gateways and base stations. A base station may include many sectors for example: 1, 2, 3, 4, or 6 sectors. A base station may include many cells, for example, ranging from 1 to 50 cells or more. A cell may be categorized, for example, as a primary cell or secondary cell. At RRC connection establishment/re-establishment/handover, one serving cell may provide the NAS (non-access stratum) mobility information (e.g. TAI), and at RRC connection re-establishment/handover, one serving cell may provide the security input. This cell may be referred to as the Primary Cell (PCell). In the downlink, the carrier corresponding to the PCell may be the Downlink Primary Component Carrier (DL PCC), while in the uplink, the carrier corresponding to the PCell may be the Uplink Primary Component Carrier (UL PCC). Depending on wireless device capabilities, Secondary Cells (SCells) may be configured to form together with the PCell a set of serving cells. In the downlink, the carrier corresponding to an SCell may be a Downlink Secondary Component Carrier (DL SCC), while in the uplink, it may be an Uplink Secondary Component Carrier (UL SCC). An SCell may or may not have an uplink carrier.

A cell, comprising a downlink carrier and optionally an uplink carrier, may be assigned a physical cell ID and a cell index. A carrier (downlink or uplink) may belong to only one cell. The cell ID or Cell index may also identify the downlink carrier or uplink carrier of the cell (depending on the context it is used). In the specification, cell ID may be equally referred to a carrier ID, and cell index may be referred to carrier index. In implementation, the physical cell ID or cell index may be assigned to a cell. A cell ID may be determined using a synchronization signal transmitted on a downlink carrier. A cell index may be determined using RRC messages. For example, when the specification refers to a first physical cell ID for a first downlink carrier, the specification may mean the first physical cell ID is for a cell comprising the first downlink carrier. The same concept may apply, for example, to carrier activation. When the specification indicates that a first carrier is activated, the specification may also mean that the cell comprising the first carrier is activated.

Embodiments may be configured to operate as needed. The disclosed mechanism may be performed when certain criteria are met, for example, in a wireless device, a base station, a radio environment, a network, a combination of the above, and/or the like. Example criteria may be based, at least in part, on for example, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

A base station may communicate with a mix of wireless devices. Wireless devices may support multiple technologies, and/or multiple releases of the same technology. Wireless devices may have some specific capability(ies) depending on its wireless device category and/or capability(ies). A base station may comprise multiple sectors. When this disclosure refers to a base station communicating with a plurality of wireless devices, this disclosure may refer to a subset of the total wireless devices in a coverage area. This disclosure may refer to, for example, a plurality of wireless devices of a given LTE release with a given capability and in a given sector of the base station. The plurality of wireless devices in this disclosure may refer to a selected plurality of wireless devices, and/or a subset of total wireless devices in a coverage area which perform according to disclosed methods, and/or the like. There may be a plurality of wireless devices in a coverage area that may not comply with the disclosed methods, for example, because those wireless devices perform based on older releases of LTE technology.

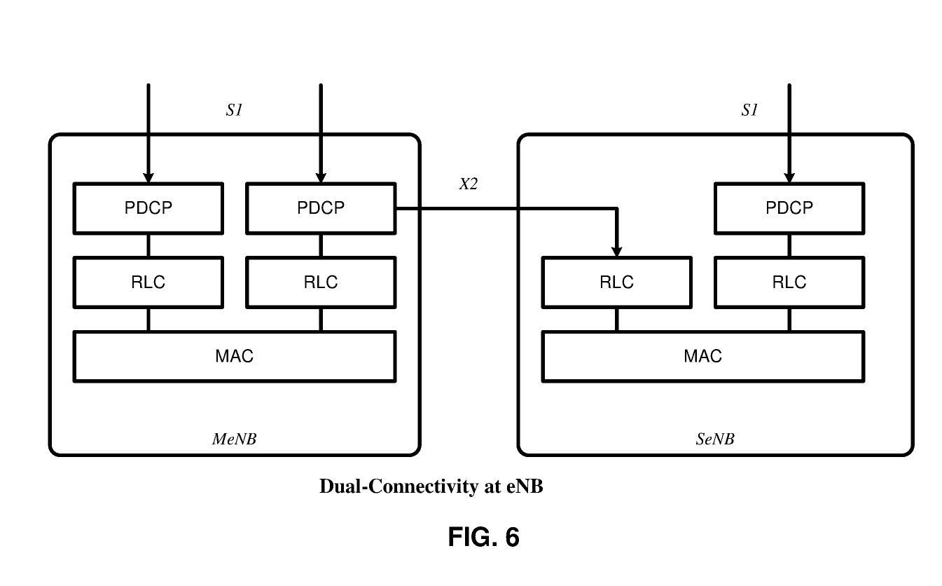

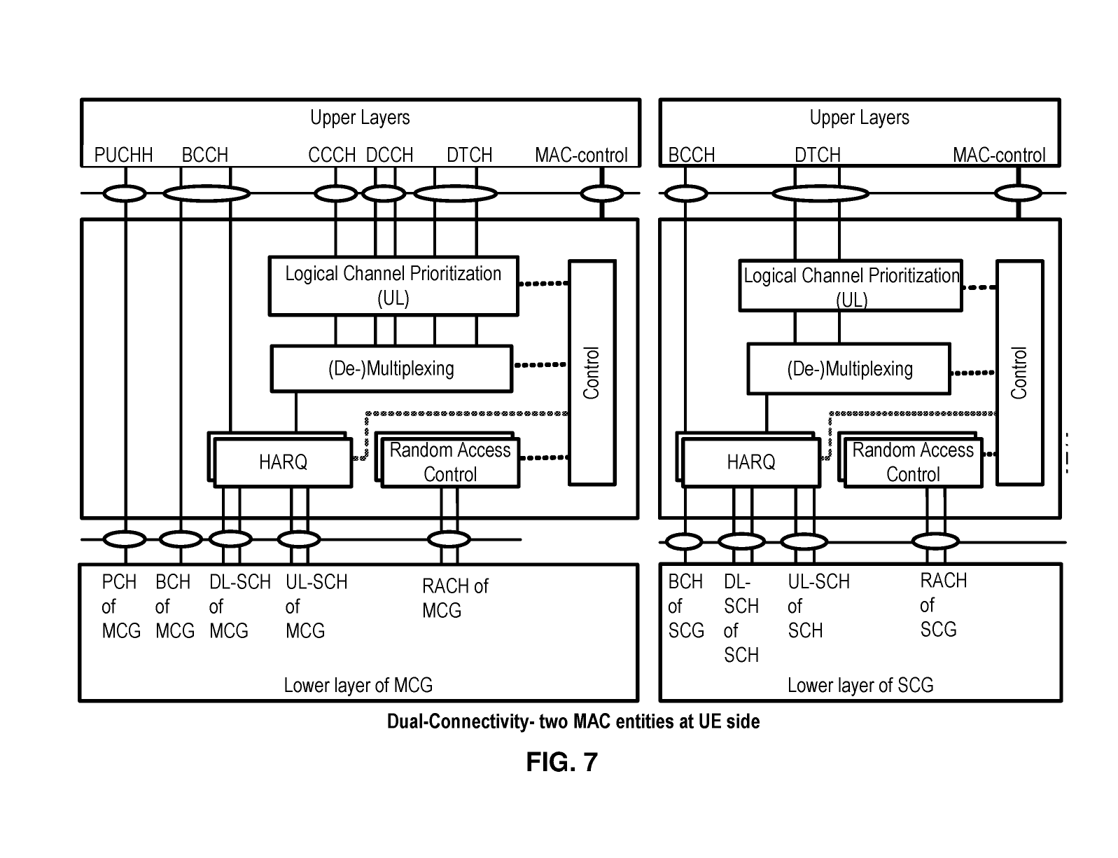

FIG. 6 and FIG. 7 are example diagrams for protocol structure with CA and DC as per an aspect of an embodiment of the present disclosure. E-UTRAN may support Dual Connectivity (DC) operation whereby a multiple RX/TX UE in RRC_CONNECTED may be configured to utilize radio resources provided by two schedulers located in two eNBs connected via a non-ideal backhaul over the X2 interface. eNBs involved in DC for a certain UE may assume two different roles: an eNB may either act as an MeNB or as an SeNB. In DC a UE may be connected to one MeNB and one SeNB. Mechanisms implemented in DC may be extended to cover more than two eNBs. FIG. 7 illustrates one example structure for the UE side MAC entities when a Master Cell Group (MCG) and a Secondary Cell Group (SCG) are configured, and it may not restrict implementation. Media Broadcast Multicast Service (MBMS) reception is not shown in this figure for simplicity.

In DC, the radio protocol architecture that a particular bearer uses may depend on how the bearer is setup. Three alternatives may exist, an MCG bearer, an SCG bearer and a split bearer as shown in FIG. 6. RRC may be located in MeNB and SRBs may be configured as a MCG bearer type and may use the radio resources of the MeNB. DC may also be described as having at least one bearer configured to use radio resources provided by the SeNB. DC may or may not be configured/implemented in example embodiments of the disclosure.

In the case of DC, the UE may be configured with two MAC entities: one MAC entity for MeNB, and one MAC entity for SeNB. In DC, the configured set of serving cells for a UE may comprise two subsets: the Master Cell Group (MCG) containing the serving cells of the MeNB, and the Secondary Cell Group (SCG) containing the serving cells of the SeNB. For a SCG, one or more of the following may be applied. At least one cell in the SCG may have a configured UL CC and one of them, named PSCell (or PCell of SCG, or sometimes called PCell), may be configured with PUCCH resources. When the SCG is configured, there may be at least one SCG bearer or one Split bearer. Upon detection of a physical layer problem or a random access problem on a PSCell, or the maximum number of RLC retransmissions has been reached associated with the SCG, or upon detection of an access problem on a PSCell during a SCG addition or a SCG change: a RRC connection re-establishment procedure may not be triggered, UL transmissions towards cells of the SCG may be stopped, and a MeNB may be informed by the UE of a SCG failure type. For split bearer, the DL data transfer over the MeNB may be maintained. The RLC AM bearer may be configured for the split bearer. Like a PCell, a PSCell may not be de-activated. A PSCell may be changed with a SCG change (for example, with a security key change and a RACH procedure), and/or neither a direct bearer type change between a Split bearer and a SCG bearer nor simultaneous configuration of a SCG and a Split bearer may be supported.

With respect to the interaction between a MeNB and a SeNB, one or more of the following principles may be applied. The MeNB may maintain the RRM measurement configuration of the UE and may, (for example, based on received measurement reports or traffic conditions or bearer types), decide to ask a SeNB to provide additional resources (serving cells) for a UE. Upon receiving a request from the MeNB, a SeNB may create a container that may result in the configuration of additional serving cells for the UE (or decide that it has no resource available to do so). For UE capability coordination, the MeNB may provide (part of) the AS configuration and the UE capabilities to the SeNB. The MeNB and the SeNB may exchange information about a UE configuration by employing RRC containers (inter-node messages) carried in X2 messages. The SeNB may initiate a reconfiguration of its existing serving cells (for example, a PUCCH towards the SeNB). The SeNB may decide which cell is the PSCell within the SCG. The MeNB may not change the content of the RRC configuration provided by the SeNB. In the case of a SCG addition and a SCG SCell addition, the MeNB may provide the latest measurement results for the SCG cell(s). Both a MeNB and a SeNB may know the SFN and subframe offset of each other by OAM, (for example, for the purpose of DRX alignment and identification of a measurement gap). In an example, when adding a new SCG SCell, dedicated RRC signaling may be used for sending required system information of the cell as for CA, except for the SFN acquired from a MIB of the PSCell of a SCG.

In an example, serving cells may be grouped in a TA group (TAG). Serving cells in one TAG may use the same timing reference. For a given TAG, user equipment (UE) may use at least one downlink carrier as a timing reference. For a given TAG, a UE may synchronize uplink subframe and frame transmission timing of uplink carriers belonging to the same TAG. In an example, serving cells having an uplink to which the same TA applies may correspond to serving cells hosted by the same receiver. A UE supporting multiple TAs may support two or more TA groups. One TA group may contain the PCell and may be called a primary TAG (pTAG). In a multiple TAG configuration, at least one TA group may not contain the PCell and may be called a secondary TAG (sTAG). In an example, carriers within the same TA group may use the same TA value and/or the same timing reference. When DC is configured, cells belonging to a cell group (MCG or SCG) may be grouped into multiple TAGs including a pTAG and one or more sTAGs.

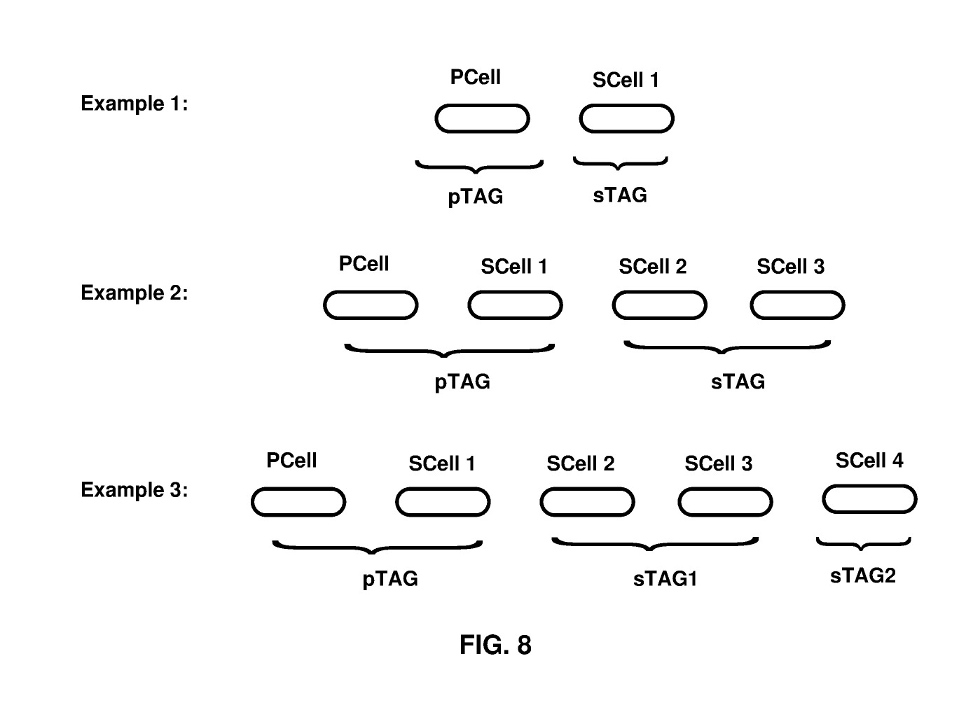

FIG. 8 shows example TAG configurations as per an aspect of an embodiment of the present disclosure. In Example 1, pTAG comprises a PCell, and an sTAG comprises SCell1. In Example 2, a pTAG comprises a PCell and SCell1, and an sTAG comprises SCell2 and SCell3. In Example 3, pTAG comprises PCell and SCell1, and an sTAG1 includes SCell2 and SCell3, and sTAG2 comprises SCell4. Up to four TAGs may be supported in a cell group (MCG or SCG) and other example TAG configurations may also be provided. In various examples in this disclosure, example mechanisms are described for a pTAG and an sTAG. Some of the example mechanisms may be applied to configurations with multiple sTAGs.

In an example, an eNB may initiate an RA procedure via a PDCCH order for an activated SCell. This PDCCH order may be sent on a scheduling cell of this SCell. When cross carrier scheduling is configured for a cell, the scheduling cell may be different than the cell that is employed for preamble transmission, and the PDCCH order may include an SCell index. At least a non-contention based RA procedure may be supported for SCell(s) assigned to sTAG(s).

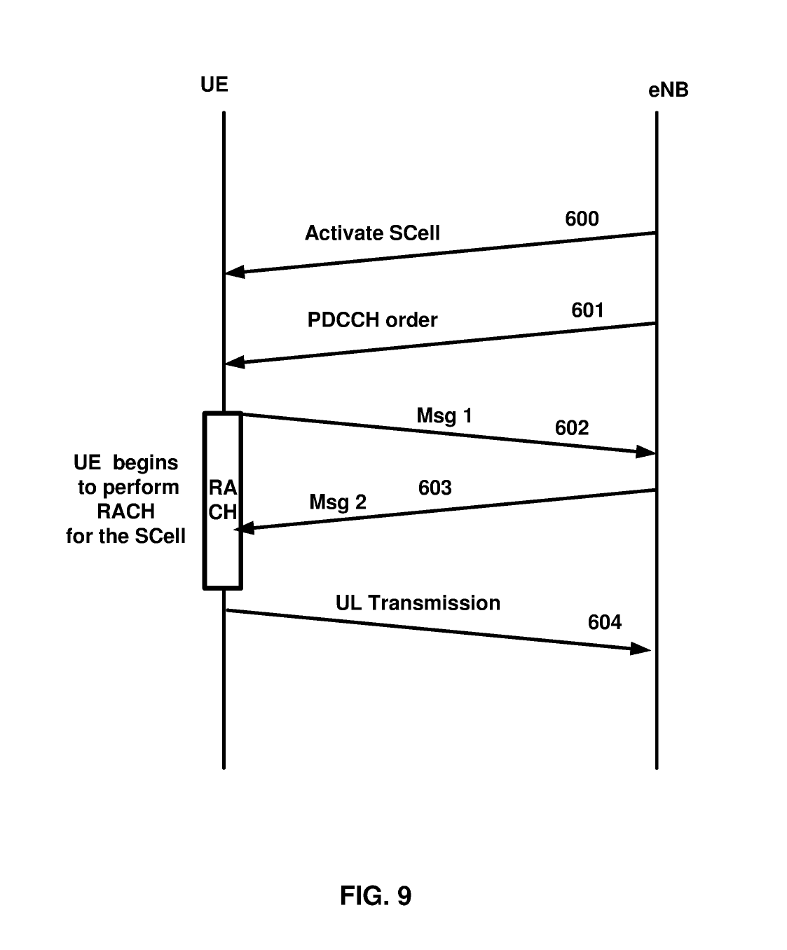

FIG. 9 is an example message flow in a random access process in a secondary TAG as per an aspect of an embodiment of the present disclosure. An eNB transmits an activation command 600 to activate an SCell. A preamble 602 (Msg1) may be sent by a UE in response to a PDCCH order 601 on an SCell belonging to an sTAG. In an example embodiment, preamble transmission for SCells may be controlled by the network using PDCCH format 1A. Msg2 message 603 (RAR: random access response) in response to the preamble transmission on the SCell may be addressed to RA-RNTI in a PCell common search space (CSS). Uplink packets 604 may be transmitted on the SCell in which the preamble was transmitted.

According to an embodiment, initial timing alignment may be achieved through a random access procedure. This may involve a UE transmitting a random access preamble and an eNB responding with an initial TA command NTA (amount of timing advance) within a random access response window. The start of the random access preamble may be aligned with the start of a corresponding uplink subframe at the UE assuming NTA=0. The eNB may estimate the uplink timing from the random access preamble transmitted by the UE. The TA command may be derived by the eNB based on the estimation of the difference between the desired UL timing and the actual UL timing. The UE may determine the initial uplink transmission timing relative to the corresponding downlink of the sTAG on which the preamble is transmitted.

The mapping of a serving cell to a TAG may be configured by a serving eNB with RRC signaling. The mechanism for TAG configuration and reconfiguration may be based on RRC signaling. According to various aspects of an embodiment, when an eNB performs an SCell addition configuration, the related TAG configuration may be configured for the SCell. In an example embodiment, an eNB may modify the TAG configuration of an SCell by removing (releasing) the SCell and adding (configuring) a new SCell (with the same physical cell ID and frequency) with an updated TAG ID. The new SCell with the updated TAG ID may initially be inactive subsequent to being assigned the updated TAG ID. The eNB may activate the updated new SCell and start scheduling packets on the activated SCell. In an example implementation, it may not be possible to change the TAG associated with an SCell, but rather, the SCell may need to be removed and a new SCell may need to be added with another TAG. For example, if there is a need to move an SCell from an sTAG to a pTAG, at least one RRC message, (for example, at least one RRC reconfiguration message), may be send to the UE to reconfigure TAG configurations by releasing the SCell and then configuring the SCell as a part of the pTAG. When an SCell is added/configured without a TAG index, the SCell may be explicitly assigned to the pTAG. The PCell may not change its TA group and may be a member of the pTAG.

The purpose of an RRC connection reconfiguration procedure may be to modify an RRC connection, (for example, to establish, modify and/or release RBs, to perform handover, to setup, modify, and/or release measurements, to add, modify, and/or release SCells). If the received RRC Connection Reconfiguration message includes the sCellToReleaseList, the UE may perform an SCell release. If the received RRC Connection Reconfiguration message includes the sCellToAddModList, the UE may perform SCell additions or modification.

In LTE Release-10 and Release-11 CA, a PUCCH may only be transmitted on the PCell (PSCell) to an eNB. In LTE-Release 12 and earlier, a UE may transmit PUCCH information on one cell (PCell or PSCell) to a given eNB.

As the number of CA capable UEs and also the number of aggregated carriers increase, the number of PUCCHs and also the PUCCH payload size may increase. Accommodating the PUCCH transmissions on the PCell may lead to a high PUCCH load on the PCell. A PUCCH on an SCell may be introduced to offload the PUCCH resource from the PCell. More than one PUCCH may be configured for example, a PUCCH on a PCell and another PUCCH on an SCell. In the example embodiments, one, two or more cells may be configured with PUCCH resources for transmitting CSI/ACK/NACK to a base station. Cells may be grouped into multiple PUCCH groups, and one or more cell within a group may be configured with a PUCCH. In an example configuration, one SCell may belong to one PUCCH group. SCells with a configured PUCCH transmitted to a base station may be called a PUCCH SCell, and a cell group with a common PUCCH resource transmitted to the same base station may be called a PUCCH group.

In an example embodiment, a MAC entity may have a configurable timer timeAlignmentTimer per TAG. The timeAlignmentTimer may be used to control how long the MAC entity considers the Serving Cells belonging to the associated TAG to be uplink time aligned. The MAC entity may, when a Timing Advance Command MAC control element is received, apply the Timing Advance Command for the indicated TAG; start or restart the timeAlignmentTimer associated with the indicated TAG. The MAC entity may, when a Timing Advance Command is received in a Random Access Response message for a serving cell belonging to a TAG and/or if the Random Access Preamble was not selected by the MAC entity, apply the Timing Advance Command for this TAG and start or restart the timeAlignmentTimer associated with this TAG. Otherwise, if the timeAlignmentTimer associated with this TAG is not running, the Timing Advance Command for this TAG may be applied and the timeAlignmentTimer associated with this TAG started. When the contention resolution is considered not successful, a timeAlignmentTimer associated with this TAG may be stopped. Otherwise, the MAC entity may ignore the received Timing Advance Command.

In example embodiments, a timer is running once it is started, until it is stopped or until it expires; otherwise it may not be running. A timer can be started if it is not running or restarted if it is running. For example, a timer may be started or restarted from its initial value.

Example embodiments of the disclosure may enable operation of multi-carrier communications. Other example embodiments may comprise a non-transitory tangible computer readable media comprising instructions executable by one or more processors to cause operation of multi-carrier communications. Yet other example embodiments may comprise an article of manufacture that comprises a non-transitory tangible computer readable machine-accessible medium having instructions encoded thereon for enabling programmable hardware to cause a device (e.g. wireless communicator, UE, base station, etc.) to enable operation of multi-carrier communications. The device may include processors, memory, interfaces, and/or the like. Other example embodiments may comprise communication networks comprising devices such as base stations, wireless devices (or user equipment: UE), servers, switches, antennas, and/or the like.

The amount of data traffic carried over cellular networks is expected to increase for many years to come. The number of users/devices is increasing and each user/device accesses an increasing number and variety of services, e.g. video delivery, large files, images. This may require not only high capacity in the network, but also provisioning very high data rates to meet customers' expectations on interactivity and responsiveness. More spectrum may therefore needed for cellular operators to meet the increasing demand. Considering user expectations of high data rates along with seamless mobility, it may be beneficial that more spectrum be made available for deploying macro cells as well as small cells for cellular systems.

Striving to meet the market demands, there has been increasing interest from operators in deploying some complementary access utilizing unlicensed spectrum to meet the traffic growth. This is exemplified by the large number of operator-deployed Wi-Fi networks and the 3GPP standardization of LTE/WLAN interworking solutions. This interest indicates that unlicensed spectrum, when present, may be an effective complement to licensed spectrum for cellular operators to help addressing the traffic explosion in some scenarios, such as hotspot areas. LAA may offer an alternative for operators to make use of unlicensed spectrum while managing one radio network, thus offering new possibilities for optimizing the network's efficiency.

In an example embodiment, Listen-before-talk (clear channel assessment) may be implemented for transmission in an LAA cell. In a listen-before-talk (LBT) procedure, equipment may apply a clear channel assessment (CCA) check before using the channel. For example, the CCA may utilize at least energy detection to determine the presence or absence of other signals on a channel in order to determine if a channel is occupied or clear, respectively. For example, European and Japanese regulations mandate the usage of LBT in the unlicensed bands. Apart from regulatory requirements, carrier sensing via LBT may be one way for fair sharing of the unlicensed spectrum.

In an example embodiment, discontinuous transmission on an unlicensed carrier with limited maximum transmission duration may be enabled. Some of these functions may be supported by one or more signals to be transmitted from the beginning of a discontinuous LAA downlink transmission. Channel reservation may be enabled by the transmission of signals, by an LAA node, after gaining channel access via a successful LBT operation, so that other nodes that receive the transmitted signal with energy above a certain threshold sense the channel to be occupied. Functions that may need to be supported by one or more signals for LAA operation with discontinuous downlink transmission may include one or more of the following: detection of the LAA downlink transmission (including cell identification) by UEs, time & frequency synchronization of UEs, and/or the like.

In an example embodiment, a DL LAA design may employ subframe boundary alignment according to LTE-A carrier aggregation timing relationships across serving cells aggregated by CA. This may not imply that the eNB transmissions can start only at the subframe boundary. LAA may support transmitting PDSCH when not all OFDM symbols are available for transmission in a subframe according to LBT. Delivery of necessary control information for the PDSCH may also be supported.

An LBT procedure may be employed for fair and friendly coexistence of LAA with other operators and technologies operating in an unlicensed spectrum. LBT procedures on a node attempting to transmit on a carrier in an unlicensed spectrum may require the node to perform a clear channel assessment to determine if the channel is free for use. An LBT procedure may involve at least energy detection to determine if the channel is being used. For example, regulatory requirements in some regions, for example, in Europe, may specify an energy detection threshold such that if a node receives energy greater than this threshold, the node assumes that the channel is not free. While nodes may follow such regulatory requirements, a node may optionally use a lower threshold for energy detection than that specified by regulatory requirements. In an example, LAA may employ a mechanism to adaptively change the energy detection threshold. For example, LAA may employ a mechanism to adaptively lower the energy detection threshold from an upper bound. Adaptation mechanism(s) may not preclude static or semi-static setting of the threshold. In an example a Category 4 LBT mechanism or other type of LBT mechanisms may be implemented.

Various example LBT mechanisms may be implemented. In an example, for some signals, in some implementation scenarios, in some situations, and/or in some frequencies, no LBT procedure may performed by the transmitting entity. In an example, Category 2 (for example, LBT without random back-off) may be implemented. The duration of time that the channel is sensed to be idle before the transmitting entity transmits may be deterministic. In an example, Category 3 (for example, LBT with random back-off with a contention window of fixed size) may be implemented. The LBT procedure may have the following procedure as one of its components. The transmitting entity may draw a random number N within a contention window. The size of the contention window may be specified by the minimum and maximum value of N. The size of the contention window may be fixed. The random number N may be employed in the LBT procedure to determine the duration of time that the channel is sensed to be idle before the transmitting entity transmits on the channel. In an example, Category 4 (for example, LBT with random back-off with a contention window of variable size) may be implemented. The transmitting entity may draw a random number N within a contention window. The size of the contention window may be specified by a minimum and maximum value of N. The transmitting entity may vary the size of the contention window when drawing the random number N. The random number N may be employed in the LBT procedure to determine the duration of time that the channel is sensed to be idle before the transmitting entity transmits on the channel.

LAA may employ uplink LBT at the UE. The UL LBT scheme may be different from the DL LBT scheme (for example, by using different LBT mechanisms or parameters), since the LAA UL may be based on scheduled access which affects a UE's channel contention opportunities. Other considerations motivating a different UL LBT scheme include, but are not limited to, multiplexing of multiple UEs in a single subframe.

In an example, a DL transmission burst may be a continuous transmission from a DL transmitting node with no transmission immediately before or after from the same node on the same CC. A UL transmission burst from a UE perspective may be a continuous transmission from a UE with no transmission immediately before or after from the same UE on the same CC. In an example, a UL transmission burst may be defined from a UE perspective. In an example, a UL transmission burst may be defined from an eNB perspective. In an example, in case of an eNB operating DL+UL LAA over the same unlicensed carrier, DL transmission burst(s) and UL transmission burst(s) on LAA may be scheduled in a TDM manner over the same unlicensed carrier. For example, an instant in time may be part of a DL transmission burst or an UL transmission burst.

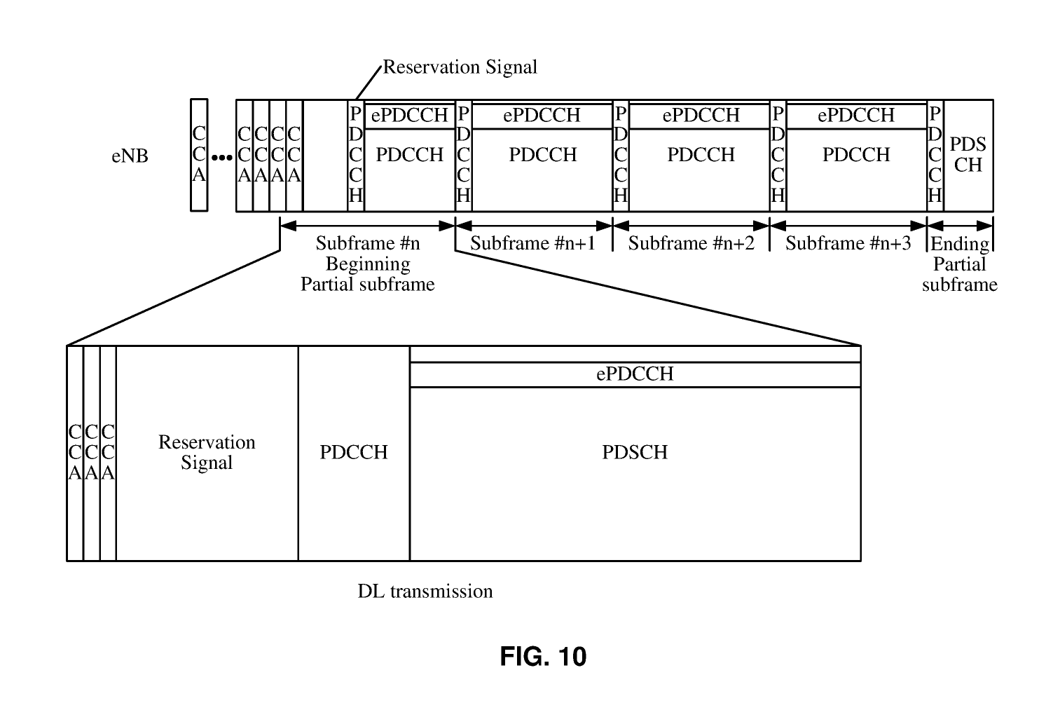

In an example embodiment, in an unlicensed cell, a downlink burst may be started in a subframe. When an eNB accesses the channel, the eNB may transmit for a duration of one or more subframes. The duration may depend on a maximum configured burst duration in an eNB, the data available for transmission, and/or eNB scheduling algorithm. FIG. 10 shows an example downlink burst in an unlicensed (e.g. licensed assisted access) cell. The maximum configured burst duration in the example embodiment may be configured in the eNB. An eNB may transmit the maximum configured burst duration to a UE employing an RRC configuration message.

The wireless device may receive from a base station at least one message (for example, an RRC) comprising configuration parameters of a plurality of cells. The plurality of cells may comprise at least one license cell and at least one unlicensed (for example, an LAA cell). The configuration parameters of a cell may, for example, comprise configuration parameters for physical channels, (for example, a ePDCCH, PDSCH, PUSCH, PUCCH and/or the like).

An enhanced frame structure type 3 may be applicable to an LAA secondary cell operation. LAA cells may employ normal cyclic prefix. In an example, a radio frame is T_{f}=307200·Tₛ=10 ms long and comprises of 20 slots of length Tₛₗₒₜ=15360·Tₛ=0.5 ms, numbered from 0 to 19. A subframe may be defined as two consecutive slots where subframe i comprises of slots 2i and 2i+1.

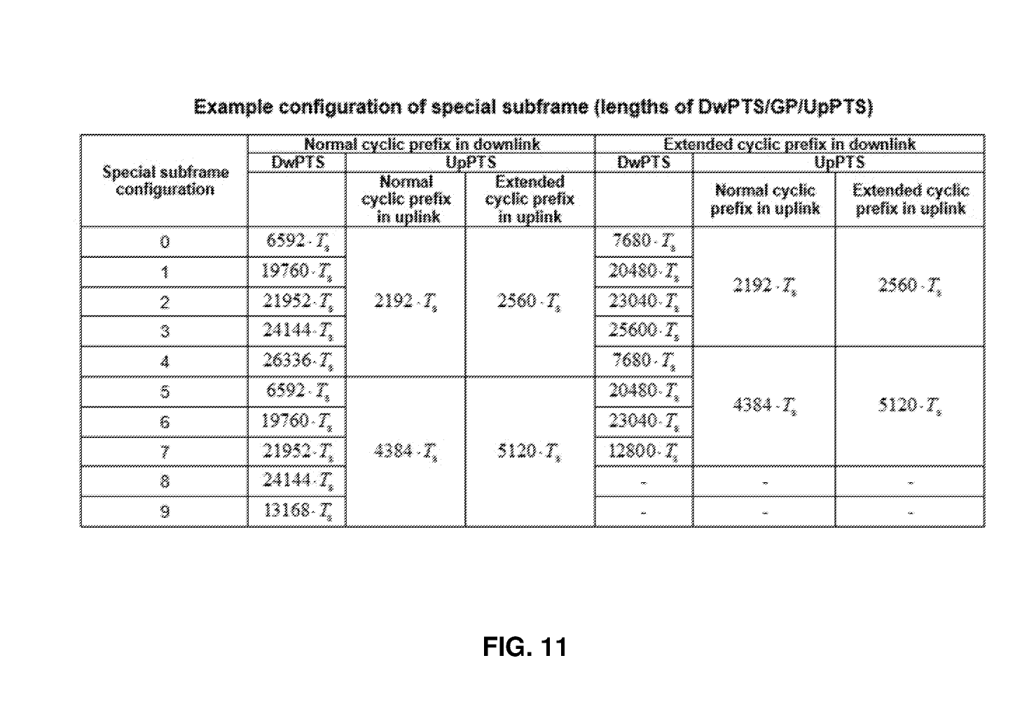

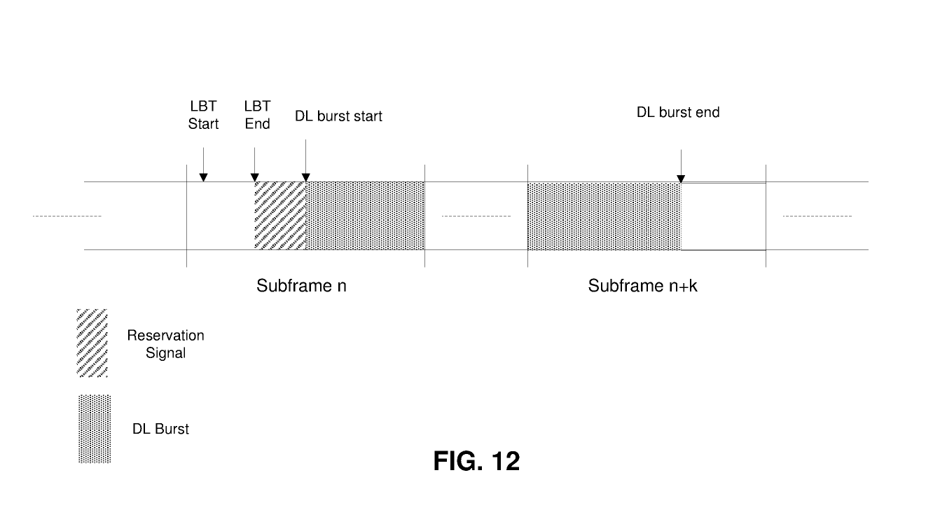

The 10 subframes within a radio frame may be available for downlink transmissions. Downlink transmissions occupy one or more consecutive subframes, starting anywhere within a subframe and ending with the last subframe either fully occupied or following one of the DwPTS durations in table in FIG. 11. An example downlink burst is shown in FIG. 12.

In an enhanced frame structure type 3 (may also be called frame structure type 3), a subframe may be used for uplink transmission.

Example embodiments of the invention describes methods and systems for random access preamble transmission in an LAA cell.

The timing alignment requirement for preamble transmission vs subframe boundaries may follow release 13 guidelines for different preamble lengths. The downlink transmission in the table in FIG. 11 may be applicable to Frame structure 2 and 3. Uplink transmissions in LAA (frame structure) may or may not be based on the able in FIG. 11 depending on UE and eNB implementation.

In an example, in a Frame structure type 3, any subframes may be used for transmission of DL burst or UL burst depending on the implementation.

In an example, if the end subframe of a DL transmission burst in an LAA cell is a partial subframe, then the end partial subframe configuration of a DL transmission burst (e.g., number of OFDM symbols) is indicated to the UE in the end subframe and the previous subframe. An eNB may transmit a DCI in a PDCCH common search space using a preconfigured CC-RNTI. The DCI may comprise a field indicating the end partial subframe configuration of a DL transmission burst (e.g., number of OFDM symbols). If the end subframe of a DL transmission burst in LAA is a full subframe, then such signaling may or may not be present.

In an example, random access procedure in an LAA SCell may be contention free and through PDDCH order. An eNB may transmit a PDCCH order to a UE. The UE may transmit a random access preamble on the LAA cell in response to receiving the PDCCH order.

If random access is initiated by eNB through PDCCH order at subframe n, the UE may transmit the preamble at subframe n+k (k>=c, e.g. c=6, 4, etc), if a PRACH resource is available. In an example, c may be a number preconfigured in the wireless device and base station. Subframes n+1 to n+c−1 may not be used for preamble transmission.

The random access preamble format 4 transmission may start 4832.7·Tₛ before the end of the UpPTS at the UE, where the UpPTS is referenced to the UE's uplink frame timing assuming N_{TA}=0. This period is approximately about 2 and 3 symbols before the end of subframe. Considering at least one symbol for LBT, a partial DL subframe may be used for transmission of preamble format 4 after the end of the DL burst, for example, when a DL partial subframe include 10 or less symbols.

In an example, a partial DL subframe with more than 10 OFDM symbols (e.g., 11 or 12 symbols) may be used for UL LBT and a preamble may be transmitted in the next subframe.

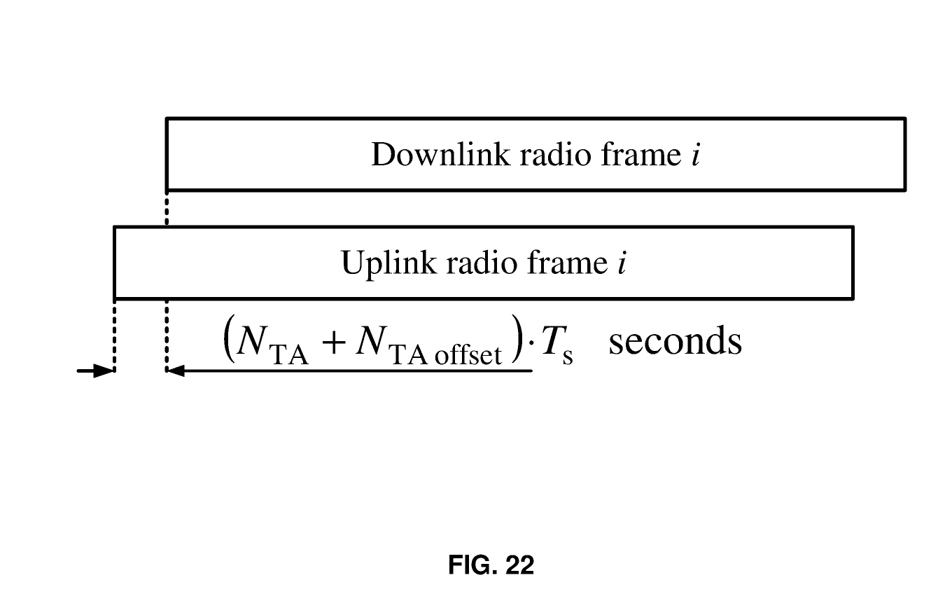

The start of the random access preamble formats 0-3 (defined for frame structure types 1 and 2) may be aligned with the start of the corresponding uplink subframe at the UE assuming N_{TA}=0, N_{TA} may be the timing offset between uplink and downlink transmission as shown in example FIG. 22.

In an example embodiment, RRC configuration index may not be employed for determining subframe configuration (indicating which subframes are used for PRACH) for an LAA PRACH resources. If a UE receives a PDCCH order in subframe n to transmit a random access preamble on an LAA cell, the UE may transmit a random access preamble (RAP) in response to a PDCCH order in any available uplink subframe on or after n+c (e.g. c=6). A UE may determine whether a subframe is available for RAP based on monitoring the physical layer signals and/or other criteria.

If an eNB transmits signals in the downlink, the UE monitors and receives the eNB downlink signals. When the eNB stops downlink transmission, then UE may look for an opportunity to transmit a random access preamble in PRACH in the available subframe.

The UE may determine a timing and/or preamble format for preamble transmission based on when the eNB ends its downlink transmission. In an example, a UE may employ LBT to determine a timing and/or preamble format for preamble transmission. In an example, a UE may transmit a preamble (e.g. format 4) without an LBT.

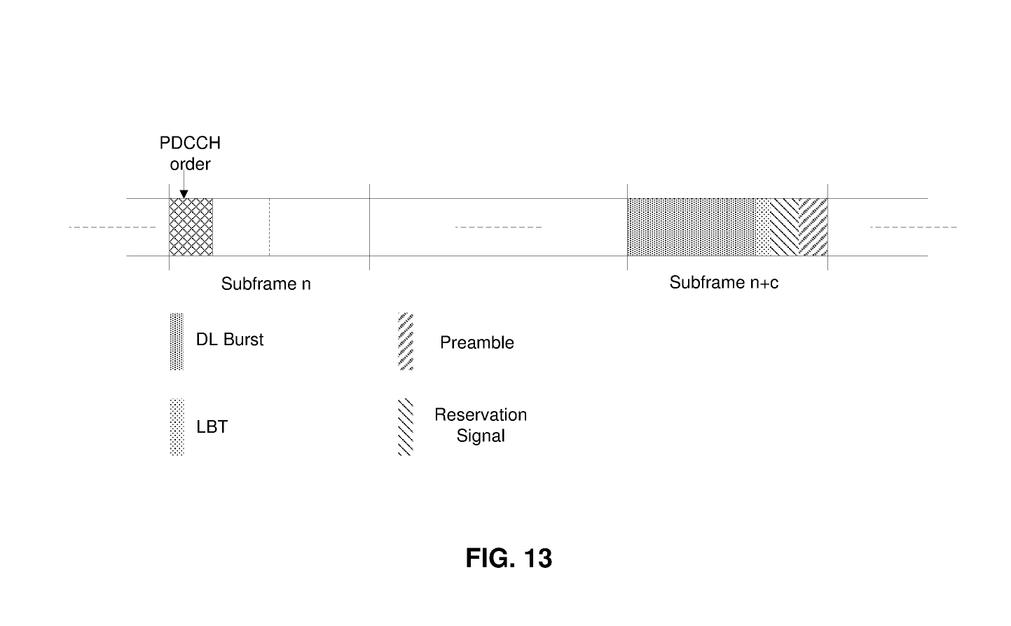

In an example embodiment, a UE may be configured to transmit preamble format 4 in response to a PDCCH order. Transmission of preamble format 4 may or may not require LBT in an implementation. If the UE receives a PDCCH order in subframe n, the UE may transmit a format 4 preamble in a subframe (on or after n+c) that is not a full downlink subframe or in a partial end subframe that the UE can transmit a preamble format 4 (considering the limitation regarding the guard period and/or DL/UL switching time and/or time needed for LBT if it is required). An example preamble transmission is shown in FIG. 13. In an example embodiment, transmission of a reservation signal may not be supported for uplink signal transmissions and a UE may transmit a preamble without transmitting a preceding reservation signal.

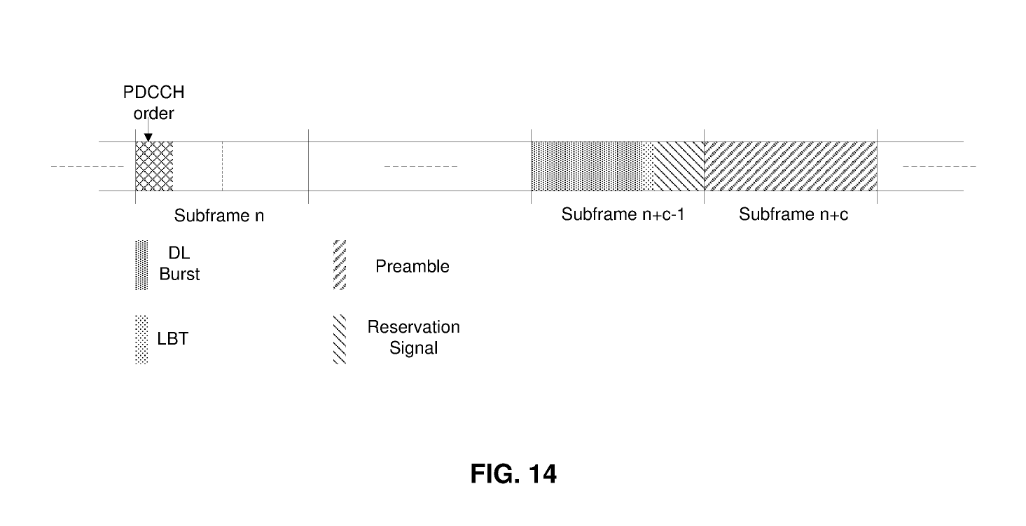

In an example embodiment, a UE may be configured to transmit a preamble with one of the formats 0-3 in response to a PDCCH order. Transmission of preamble formats 0-3 may require LBT in an implementation. If the UE receives PDCCH order in subframe n, the UE may transmit a format 0-3 preamble in a subframe (on or after n+c) that is not a full or partial downlink subframe. The UE may be required to perform LBT in the previous subframe to detect a clear channel. The LBT may be performed in a partial end subframe or any subframe after a full downlink subframe. The UE may reserve the channel after successful completion of LBT until the subframe boundary where preamble format 0-3 can be transmitted. An example is shown in FIG. 14. In an example embodiment, transmission of a reservation signal may not be supported for uplink signal transmissions and a UE may transmit a preamble without transmitting a preceding reservation signal.

In an example embodiment, a UE may be configured to transmit a preamble in response to a PDCCH order and the UE may decide what preamble format to choose depending on what preamble format is more suitable for the first transmission opportunity. If the UE receives PDCCH order in subframe n, the UE may transmit the preamble in a subframe (on or after n+c). For example, a UE may choose from preamble format 0 and 4 depending on when resources for uplink preamble transmission is available.

In an example embodiment with multiple LAA secondary cells, a UE may be configured to transmit a preamble format 4, or may be configured to transmit a preamble with one of the formats 0-3, or may be configured to transmit a preamble with any format that is more suitable for a first transmission opportunity on an LAA secondary cell in response to a PDCCH order sent by the eNB.

In an LAA system, when an eNB transmits a full downlink subframe, the next available subframe for uplink transmission may be a partial uplink subframe due to transmission gap, NTA requirements, and/or LBT process. In an LAA system, when an eNB transmits an end partial downlink subframe, the next available subframe for uplink transmission may be a full or partial uplink subframe due to transmission gap, NTA requirements, and/or LBT.

In an example implementation, cells in a first group of multiple LAA cells may be aggregated and a UE may not be capable of simultaneous reception and transmission in the aggregated LAA cells. For example, the cells may be in the same band. For example, the cells may be in adjacent frequencies in the same band. This may be due to a software and/or hardware limitation in the wireless device.

Some or all of the cells in the first group of the multiple LAA cells may be capable of simultaneous reception and transmission with the PCell and/or other licensed cells. For example, an LAA cell in the first group may be able to transmit signals while receiving signals on a PCell. In this case, applying constraints to the UE on transmission and reception of signals on LAA based on the state of the PCell (downlink, uplink, or special subframe) seems to be an inefficient and sub-optimal solution.

In an example, a second group of multiple LAA cells different from the first group may be configured. The second group of multiple LAA cells may be aggregated and a UE may not be capable of simultaneous reception and transmission in the aggregated LAA cells of the second group. For example, the cells in the same cell group may be in the same band. For example, the cells may be adjacent in frequency in the same band.

A cell in the first group may transmit signals while a cell in the second group is receiving signals, and vice versa. For example, cells in the first group may be in a first band and the cells in the second group may be in a second band. For example, cells in the first group may employ a first transceiver and cells in the second group may employ a second transceiver. The example embodiments may separately apply to a first group and a second group.

In an example implementation, the cells in the first group may be have their own limitations with respect to simultaneous reception and transmission in the aggregated cells of the first group. In an example implementation, the cells in the second group may be have their own limitations with respect to simultaneous reception and transmission in the aggregated cells of the second group. Cells in different licensed bands may have their own constraints on simultaneous reception and transmission in the aggregated cells.

In an implementation, cells may be grouped according to their limitations on simultaneous reception and transmission in the aggregated cells.

In an example embodiment, a UE may not assume that LAA cells may follow the same uplink and downlink subframes as the PCell. A PCell may employ frame structure Type 1 or 2, while an LAA cell may employ frame structure Type 3. In an example embodiment, constraints are introduced for a UE and/or eNB for cells in a group to reduce the transmit and/or receive possibilities. This may reduce unnecessary signal processing in the UE and/or eNB. The constraints may be employed by the UE and/or eNB to reduce battery power consumption in the UE and/or eNB. The constraints may be applicable to the cells within a cell group, for example, the cells in the licensed band, a first group of cells in an unlicensed band A, a second group of cells in an unlicensed band B, etc. Example embodiments improve LAA cell efficiency and reduces UE battery power consumption and reduces UE processing requirements.

In an example embodiment, cells may be grouped based on simultaneous reception and transmission in the aggregated cells in a group. A UE may not be capable of simultaneous reception and transmission in the aggregated cells within a cell group.

In an example embodiment, a UE may transmit an RRC message (e.g. UE capability message) to the eNB. The message may comprise one or more parameters indicating the UE capability with respect to the example cell grouping. For example, the one or more parameters may indicate certain frequency bands, in which cells are grouped within a cell group. For example, the one or more parameters may comprise a set of frequencies that are in a cell group. For example, the one or more parameters may be a transceiver parameter in the UE indicating the frequency bands in which cells may be grouped. For example, the one or more parameters may indicate a device category or certain capability that indicate the limitation on cell aggregation to the UE.

In an example, such an aggregation limitation in different cell groups may be a characteristic of the UE, and an eNB may not be informed about such limitation. In an example embodiment, the aggregation limitation may be pre-specified in both eNB and UE based on bands, cell frequencies, cell bandwidth, and/or other parameters.

In an example, an eNB may configure the cell grouping in the UE. An eNB may transmit one or more messages to the UE configuring cell grouping based on simultaneous reception and transmission capability in the aggregated cells within a cell group. For example, an eNB may transmit one or more RRC messages comprising cell indexes of a cell group (e.g. identified by a group index). The one or more RRC message may associate the cells with a group, e.g. using a cell group index.

In an example embodiment, a cell in a group may be considered a lead cell. A lead cell may be preconfigured by an RRC message. An RRC message may comprise one or more parameters, e.g. a cell index, of a cell in a cell group. In an example, an RRC may comprise one or more configuration parameters for an SCell that implicitly or explicitly indicates that the cell is a lead cell in a group. In an example, the lead cell may be determined according to a predefined rule, for example the cell with a lowest cell index, and/or the like. The predefined rule may be configured in a UE and/or an eNB.

In an example embodiment, the lead cell may be identified by a UE on a subframe by subframe basis. In an example embodiment, there is no need to select a lead cell, and a collective constraint may be applied to the cells in a group at any moment. In an example, the cell that has certain characteristics at a moment (e.g. eNB is transmitting, UE is transmitting) may determine the status of other cells. In an example, a lead cell may be any cell in a cell group.

In an example implementation, when a UE is not capable of receiving downlink signals in a group at certain time, the UE may not decode downlink signals of cells of a group at that certain time. The UE may not blind decode the downlink cell and/or search for downlink signals. The UE may not expect to receive and monitor downlink signals such as synchronization signals, DRS, control channels (PCFICH, PDCCH, ePDCCH, PDSCH, and/or CRS, etc). This may reduce the battery power consumption in the UE, since the UE may not decode the receive signals. For example, the UE may turn off the receiver on one or more cells in a group. The UE may selectively monitor downlink signals/channels of a subframe based on downlink and uplink transmissions in another cell in the group.

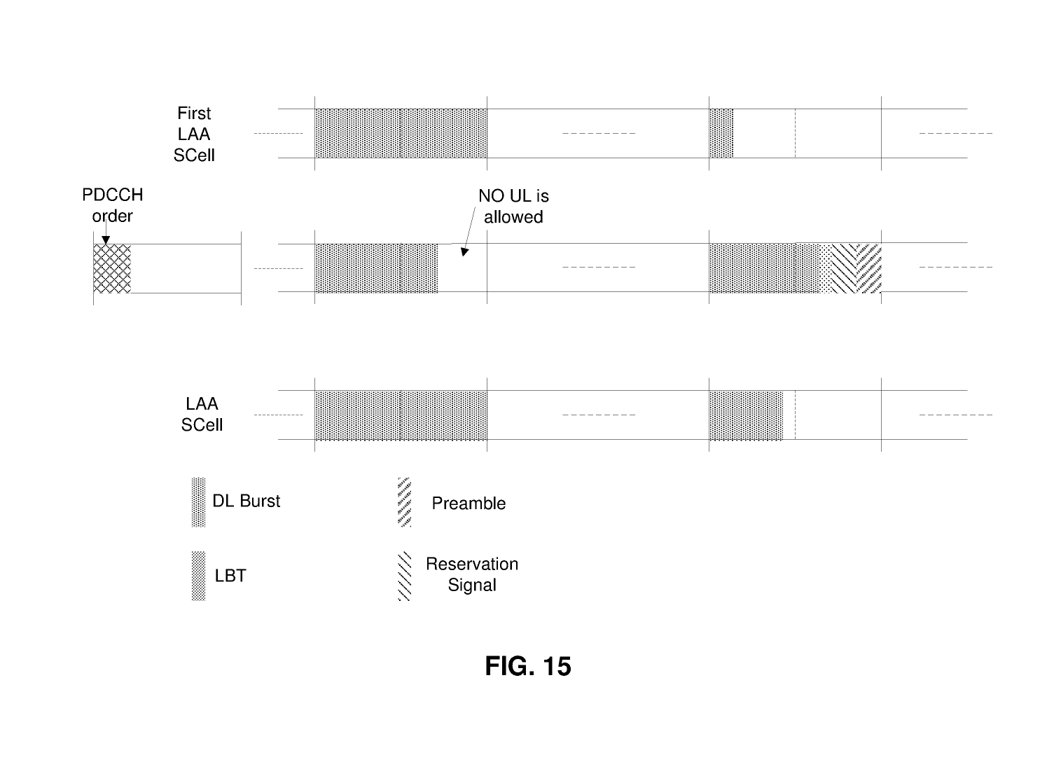

In an example, the UE may not be capable of simultaneous reception and transmission in a group of LAA secondary cells. The UE may consider one or more of the LAA secondary cells as a first LAA secondary cell(s) based on a number of criteria. The LAA secondary cell for which the PDCCH order has been sent may not be the first LAA secondary cell. The UE may transmit the preamble during the time periods that the first LAA secondary cell is not receiving downlink data. An example is shown in FIG. 15. In an example, a UE may not transmit a random access preamble in the uplink of an LAA cell during a time it is receiving downlink signals in one or more other LAA cells of a group of LAA cells.

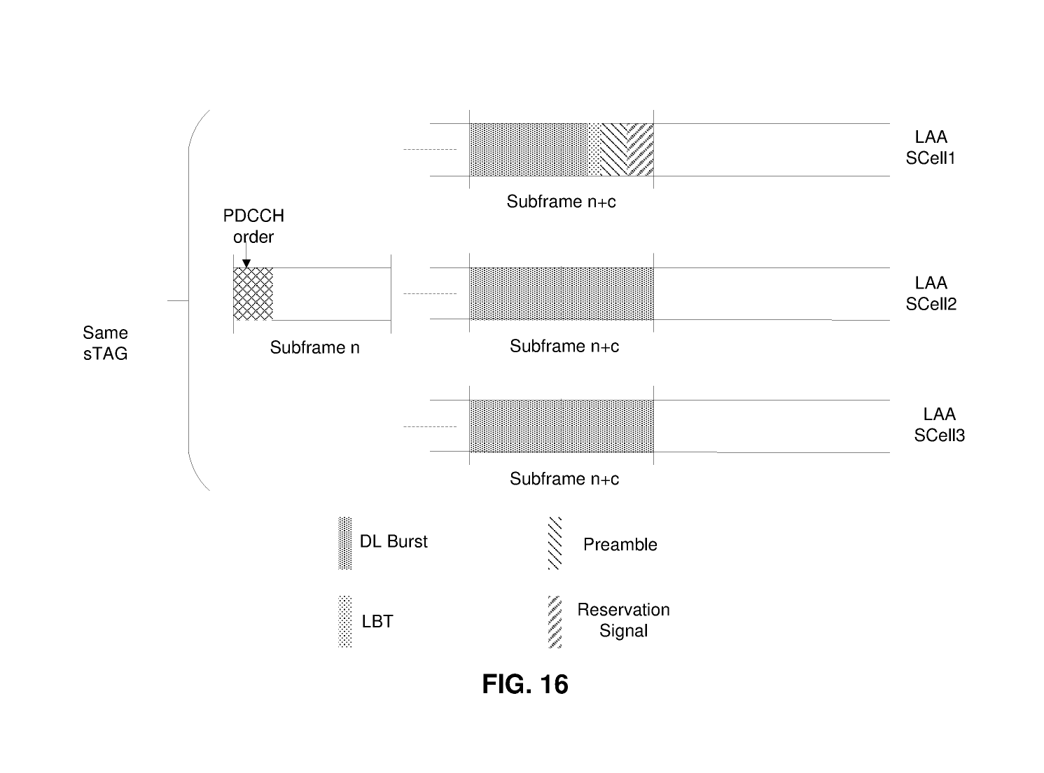

In an example embodiment with multiple LAA secondary cells, a UE may be configured to transmit a preamble format 4, or may be configured to transmit a preamble with one of the formats 0-3 (e.g. preamble format 0), or may be configured to transmit a preamble with a format that is more suitable for the first transmission opportunity on a LAA secondary cell in response to a PDCCH order sent by eNB (e.g. preamble 0 or 4). A UE may choose to transmit the preamble on one of one or more activated LAA secondary cells in the same timing advance group when the opportunity for preamble transmission on an activated LAA secondary cell in the same timing advance group becomes available. An example is shown in FIG. 16.

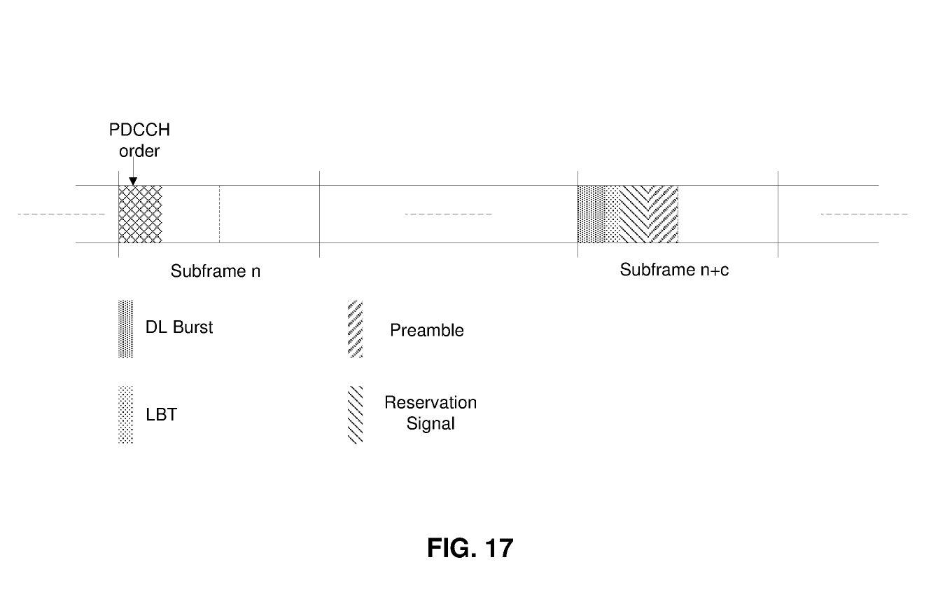

In an example embodiment, a UE may be configured to time align the end of preamble format 4 with slot boundary instead of subframe boundary. This may be beneficial when the last subframe of DL burst is a partial subframe with a small number of symbols (e.g., 3 symbols or less). The UE may perform LBT and transmit a preamble in the first slot of subframe and potentially avoid transmitting a reservation signal or the UE may transmit a short reservation signal. An example is shown in FIG. 17.

In an example, a method may be used that comprises receiving by a wireless device an RRC message configuring an unlicensed cell; receiving a PDCCH order to transmit a random access preamble on the unlicensed cell; and transmitting in a subframe the random access preamble, wherein the subframe is a first available subframe after a downlink transmission burst ended. In an example, the first available subframe may be an end partial subframe when a burst transmission duration of the end partial subframe is below a threshold value and a preamble format 4 may be transmitted. In an example, the first available subframe may be a subframe subsequent to an end full subframe and/or an end partial subframe when a burst transmission duration of the end partial subframe is above a threshold value.

In an example embodiment, an RRC configuration index may be employed for determining subframe configuration (indicating which subframes are used for PRACH) for LAA PRACH resources. In an example embodiment, RRC may configure PRACH resources for transmission of a random access preamble. Unlike licensed cells, a subframe for PRACH resource may not be available for uplink transmission for many reasons. For example, PRACH subframe may not be available when an eNB transmits downlink burst on the LAA cell (or any other LAA cell of a group of LAA cells) during a PRACH subframe in the unlicensed cell with configured PRACH. In an example, PRACH subframe may not be available when the eNB transmits a downlink burst during a PRACH subframe on another cell (e.g. of a group, e.g. unlicensed cell in the same band). The UE may not be capable of simultaneous reception and transmission in the aggregated cells.

In an example embodiment, a UE may transmit a random access preamble on a configured PRACH resource if the criteria for the preamble transmission have been met (e.g., UE has completed LBT and/or has gained access to the channel). An eNB may or may not take into account the presence of a PRACH resource on a particular subframe in its downlink scheduling. In an example, an eNB may provide PRACH subframe configuration in an RRC message for an licensed cell cell. The eNB may not provide PRACH subframe configuration in an RRC message for an LAA cell. A subframe may be selected by a UE for random access preamble transmissions per one or more example embodiments.

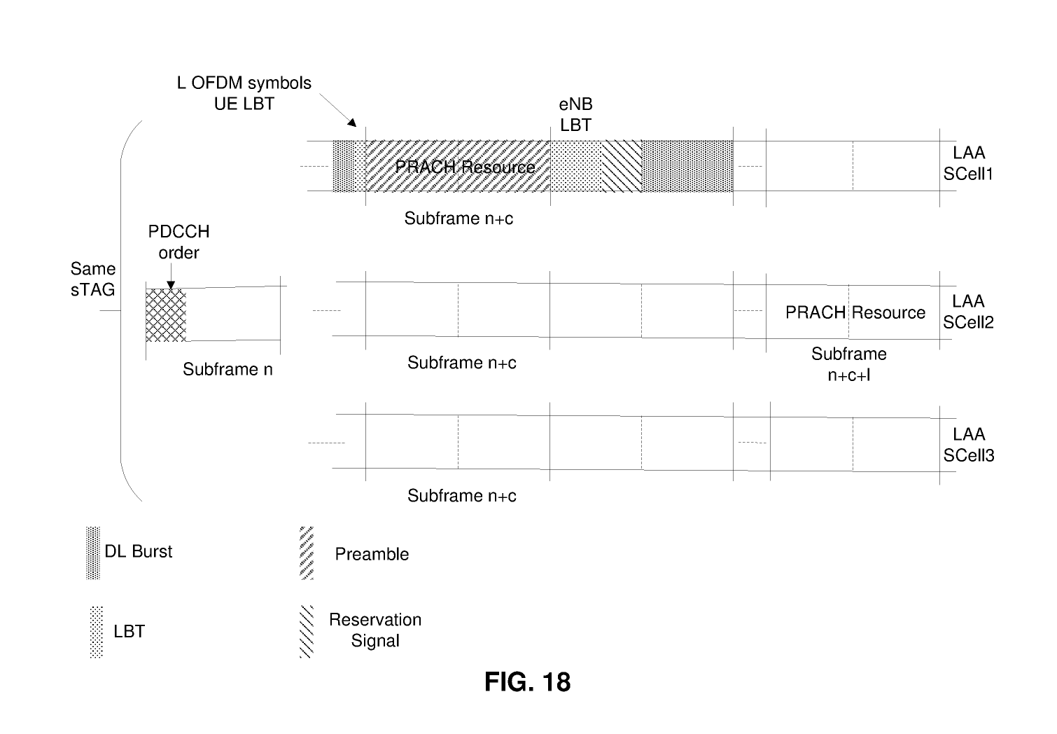

In another example, the eNB may provide PRACH subframe configuration in an RRC message for an LAA cell. In an example embodiment, an eNB may stop the downlink burst transmission so that PRACH resource meets random access transmission criteria. An eNB MAC scheduler may stop the downlink burst prior to a PRACH resource, for example when a PRACH process is pending. If an eNB sends PDCCH order to a UE at subframe n for transmission of a random access preamble, for PRACH resources that are available according to the PRACH configuration in subframes n+x (e.g. x>=6), the eNB may stop transmission L OFDM symbols (or L micro seconds) before a configured PRACH resource on the same LAA secondary cell or any other activated LAA secondary cell in the same timing advanced group. Value of L may depend on an implementation of UL LBT for PRACH and may be configurable via RRC signaling. An example is shown in FIG. 18.

In an example embodiment, if an eNB sends a PDCCH order to a UE at subframe n to send the random access preamble, for PRACH resources that are available according to the PRACH configuration in subframes n+x (e.g. x>=6), and if the UE is capable of sub-band LBT (e.g., LBT that can be performed on subsets of the entire bandwidth), the eNB may avoid scheduling downlink transmission L OFDM symbols and on the frequency band where LBT is performed and includes the resource blocks corresponding to the PRACH resources.

In an example embodiment with multiple LAA SCells where a UE is configured to transmit preamble on a given LAA SCell, a UE may update a counter with the number of times that preamble transmission was held back due to unsuccessful LBT. The UE may inform eNB about the value of this counter (e.g., on PUCCH/PUSCH of PCell or PUSCH of another SCell). In an example, the UE may autonomously switch to a different cell in the same TAG using for example the same PRACH resources that were configured in the first LAA SCell when the counter is above a threshold. In an example, an eNB may take into account the value of this counter and change the PRACH configuration index for the SCell. In an example, an eNB may take into account the value of this counter and send a PDCCH order to initiate random access on a different LAA SCell in the same TAG.

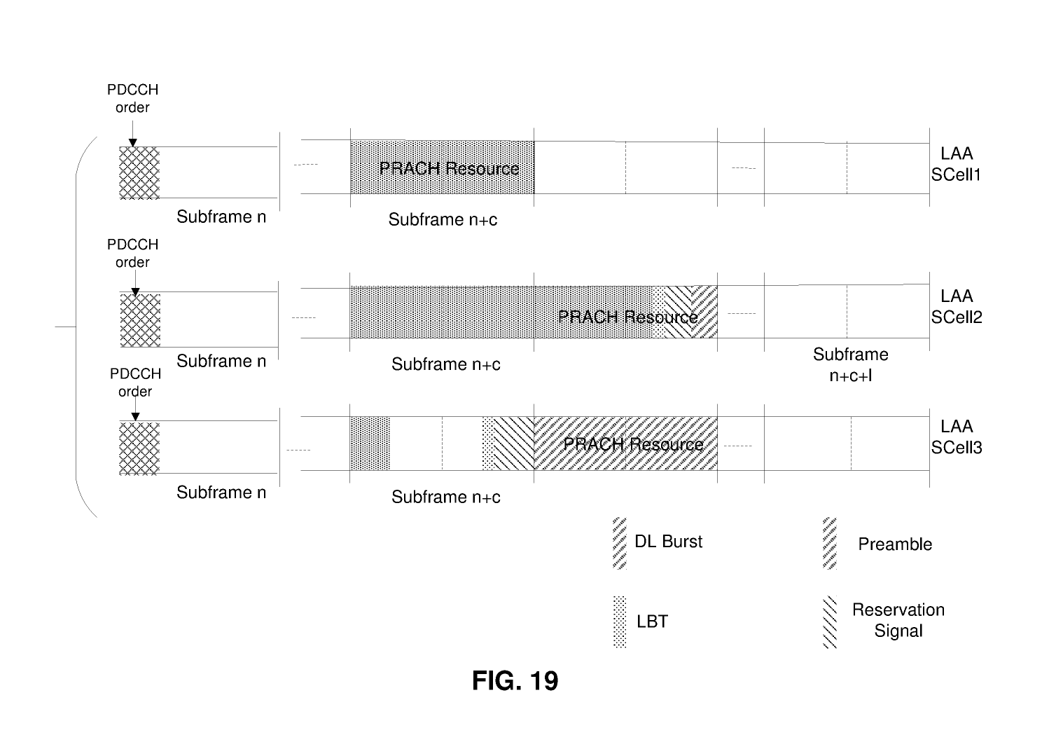

In an example embodiment with multiple LAA SCells, an eNB RRC configures the PRACH resources on a set of active LAA Scells (e.g., with PDCCH on PCell or separately with PDCCHs on the LAA SCells) that are active and are within the same TAG. eNB may choose similar or different PRACH configuration indices for different configured carriers. In an example, a UE may transmit the preamble on any PRACH opportunity available on any of the cells within the TAG. In this example, a UE may choose to transmit multiple preambles in the same subframe. In an example, a UE may choose to transmit a single preamble in a subframe based on a number of criteria. A UE may not attempt to re-transmit a preamble after successful transmission of a preamble. A UE may resume preamble transmission using the same procedure as above if no RAR is received on PCell within a configurable time window. An Example PDCCH order and preamble transmission is shown in FIG. 19.

In an example implementation, a UE may transmit preamble format 4 as described in example implementations. An eNB may send a PDCCH order to initiate a random access process for a UE at subframe n. The UE may determine (e.g., from common PDCCH signaling or blind decoding) that subframe n+x (x>=1) is at least one of the following: DL partial subframe, full DL subframe, an empty subframe, or an uplink subframe.

In an example, a UE may determine that subframe n+x (x>=1) is a DL partial subframe and and the number of DL symbols. The subframe may be used for preamble transmission depending on the implementation.

In an example, if x>=c and the partial subframe has at most 10 OFDM symbols, the subframe may be used for preamble transmission. The UE may send a signature reservation signal (e.g., a reservation signal containing the UE information) until it sends the preamble in the same subframe. If the UE gains access to the channel after the starting time of preamble, and if long channel reservation (e.g., roughly 1 ms) is allowed, the UE may send a signature reservation signal until it sends the preamble in the next subframe. In an example, if preamble format 4 is allowed to end at slot boundary, the duration of reservation signal may be shorter.

In an example, if x>=c and the partial subframe has more than 10 OFDM symbols, the subframe may be used for LBT and channel reservation and the subsequent subframe may be used for preamble transmission if long channel reservation (e.g., roughly 1 ms or 0.5 ms if preamble format 4 can end at slot boundaries) is allowed. In case long channel reservation is allowed, a UE may start LBT either (i) immediately after the downlink burst, or (ii) w microseconds before the end of subframe. If a UE gains access to the channel, the UE may send a signature reservation signal until it sends the preamble in the next subframe.

In an example, a UE may determine that subframe n+x (x>=1) is a full DL subframe, in which case it may not be used for preamble transmission and/or LBT/channel reservation.

In an example, a UE may determine that subframe n+x (x>=1) is an empty subframe, in which case it may be used for the uplink transmission. In an example, if x>=c, the UE may start LBT at w microseconds before the end of the subframe and if the UE gains access to the channel before the starting time of the preamble, the UE sends a signature reservation signal until the UE sends the preamble in the same subframe. If a UE gains access to the channel after the starting time of preamble, and if long channel reservation (e.g., roughly 1 ms 0.5 ms if preamble format 4 can end at slot boundaries) is allowed, the UE may send a signature reservation signal until it sends the preamble in the next subframe.

In an example, a UE may determine that subframe n+x (x>=1) is an uplink subframe. If x>=c, transmit data or reservation signal before the starting point of preamble transmission and then send the preamble in the same subframe.

In an example implementation, a UE may transmit one of the preamble formats 0 to 3 as described in example implementations. An eNB may send PDCCH order for initiating the random access to the UE at subframe n. The UE may determine (e.g., from common PDCCH signaling or blind decoding) if subframe n+x (x>=1) is one of the following: DL partial subframe, full DL subframe, an empty subframe or an UL subframe.

In an example, the UE may determine that subframe n+x is a DL partial subframe. In an example, if x>=c−1, UE may start the LBT either (i) immediately after the DL burst, or (ii) w microseconds before the end of subframe. If the UE gains access to the channel, the UE may send a signature reservation signal until the end of subframe and may transmit preamble at the next subframe.

In an example, the UE may determine that subframe n+x is a full DL subframe, in which case it may not be used for preamble transmission. The next subframe also may not be used for PRACH, because the UE needs to switch and possibly perform LBT.

In an example, the UE may determine that subframe n+x is an empty subframe, in which case the subframe can be used for the uplink transmission. In an example, if x>=c and the UE has gained access to and may have reserved the channel in the last subframe, the UE may transmit a preamble. In an example, if the UE has not gained access to and/or reserved the channel in the last subframe and x>=c−1, the UE may perform LBT w microseconds before the end of the subframe. In an example, if UE gains access to the channel, it may send a signature reservation signal until the end of the subframe. It may then send the preamble in the next subframe.

In an example, the UE may determine that subframe n+x is an UL subframe. In an example, if x>=c, UE may send the preamble.

In an example embodiment, a UE may transmit one of preamble configurations 0 to 4. In an example, a UE may select from one of the preamble format 0 to 4. In an example, the eNB may select preamble format 0 or 4. The eNB may send PDCCH order for initiating the random access to the UE at subframe n. The UE may determine (e.g., from common PDCCH signaling or blind decoding) if subframe n+x (x>=1) is one of the following: DL partial subframe, full DL subframe, an empty subframe or an UL subframe.

In an example, the UE may determine that subframe n+x is a DL partial subframe and if so, the number of OFDM symbols. In an example, if x>=c and the partial subframe has at most 10 OFDM symbols, the subframe may be used for preamble transmission. The UE may start LBT either (i) immediately after the downlink burst, or (ii) w microseconds before the end of subframe. If the UE gains access to the channel before the starting time of preamble format 4, the UE may send a signature reservation until it sends the preamble (format 4) in the same subframe. If the UE gains access to the channel after the starting time of preamble format 4 but before the end of subframe, the UE may send a signature reservation signal until the end of subframe and sends the preamble (format 0-3) in the next subframe.

In an example, if x>=c and the partial subframe has more than 10 OFDM symbols, the UE may start LBT either (i) immediately after the downlink burst, or (ii) w microseconds before the end of subframe. If the UE gains access to the channel, the UE may send a signature reservation until the end of subframe and may transmit the preamble (format 0-3) in the next subframe.

In an example, if x=c−1, the UE may start LBT either (i) immediately after the downlink burst, or (ii) w microseconds before the end of subframe. If the UE gains access to the channel, the UE sends a signature reservation until the UE sends the preamble in the next subframe.

In an example, the UE may determine that subframe n+x is a full DL subframe, in which case it cannot be used for preamble transmission. The next subframe may be used for transmission of preamble format 4.

In an example, the UE may determine that subframe n+x is an empty subframe. In an example, if x>=c and UE has gained access to and reserved the channel in the last subframe, the UE may transmit a preamble (format 0-3). In an example, if a UE has not gained access to and/or reserved the channel in the last subframe and x>=c, UE may perform LBT w microseconds before the end of the subframe (or slot boundary if preamble format 4 can end at slot boundaries). Once UE gains access to the channel, the UE may send a signature reservation signal until it sends preamble (format 4) in the same subframe. In an example, if x=c−1, UE may perform LBT w microseconds before the end of the subframe. Once UE gains access to the channel, the UE may send a signature reservation signal until the UE sends the preamble in the next subframe.

In an example, the UE may determine that subframe n+x is an UL subframe. In an example, if x>=c, the UE sends the preamble.

In an example embodiment, if multiple LAA SCells in the same time advance group are activated, the UE may transmit the random access preamble in any of the SCells as soon as it finds the opportunity.

In an example, the eNB may send PDCCH order for initiating the random access to the UE at subframe n. The UE may determine (e.g., from common PDCCH signaling or blind decoding) if subframe n+x (x>=1) in any of the SCells of the same timing advance group is a DL partial subframe, full DL subframe, an empty subframe or an UL subframe.

In an example, if x>=c and there is opportunity for preamble transmission in any of SCells, the UE may transmit a preamble the Scell.

In an example, if at a given subframe, there is an opportunity for preamble transmission on multiple LAA SCells, the UE may send multiple preambles on different LAA SCells and at the same subframe.

In an example, if at a given subframe, there is an opportunity for preamble transmission on multiple LAA SCells, the UE may select to transmit a single preamble on only one of the LAA SCells based on some criteria. For example, if the UE can send a preamble format 4 on one LAA SCell and preamble format 0 on another LAA SCell, the UE may select to transmit preamble format 0 only.

In an example, if a UE has not received signaling regarding next subframe, the UE may determine that the subframe may be either empty or a full DL subframe.

In an example, a UE may determine from common PDCCH signaling if the next subframe is a DL partial subframe. The subframe may be used for LBT and transmission of random access preamble format 4 and/or channel reservation for transmission of random access preamble in the subsequent subframe.

Depending on implementation and/or preamble format a UE may or may not transmit reservation or signature signals before the preamble transmission.

If there is no DCI information, the UE may perform blind decoding at the beginning of subframe n+x to see if there is any DL transmission. If so, the UE may determine that subframe n+x is a full DL subframe.

If blind decoding is not successful, then subframe n+x may be one of the following: blank, or occupied by other base stations.

In an example, the UE may start the LBT process right after the end of a DL burst. If the UE gains access to the channel, the UE may transmit a reservation signal until the beginning of a preamble transmission.

A UE may start the LBT at min {w us, (1 ms-duration of DL transmission)} before the end of subframe. If the UE gains access to the channel, the UE may send a reservation signal until the beginning of preamble transmission.

A UE may not start the LBT until slot boundary (even if partial DL subframe ends before the slot boundary or even if the subframe is empty). If the UE gains access to channel, the UE may send a signature reservation signal until preamble transmission.

In an example embodiment, an enhanced double LBT mechanism may be implemented to improve PRACH transmission.

In an example, a UE may perform LBT right after the end of DL burst.

In an example, if UE gains access to the channel before the slot boundary, the UE may send a signature reservation signal until the slot boundary. The eNB may or may not honor this reservation signal. The UE may start LBT at the slot boundary to verify if the eNB is transmitting. If the eNB is not transmitting after the slot boundary, the UE continues sending the reservation signal until the end of the subframe (SF) and sends the preamble (format 0-3) at the beginning of next SF n. If the eNB transmits after the slot boundary, the UE may not transmit a reservation signal after the slot boundary and may not be able to transmit the preamble in the next subframe.

In an example, if a UE gains access to the channel before the slot boundary, the UE sends a signature reservation signal until the slot boundary. The eNB may or may not honor this reservation signal. The UE may start LBT at the slot boundary to verify if the eNB is transmitting. If the eNB is not transmitting after the slot boundary, the UE may continue sending the reservation signal until the UE transmits preamble (format 4) aligned with the end of the subframe. If the eNB transmits after the slot boundary, the UE may not transmit a reservation signal after the slot boundary and may not be able to transmit the preamble in the subframe.

In an example embodiment, one or more counters and/or timers may be configured for one or more LBT processes in a UE. A UE may maintain one or more counters, for an active LAA cell, that is incremented when an uplink transmission attempt fails due to unsuccessful LBT. For example, the UE may not be able to transmit data at a subframe allocated by an uplink grant because LBT for the UE may not indicate a clear channel. For example, when LBT may not indicate a clear channel before the last position within the subframe that can be used for uplink transmission. In an example, the UE may not be able to use a PRACH resource configured by RRC and transmit a preamble because the PRACH resource may not be available when LBT does not indicate a clear channel.

In an example implementation, a UE may maintain the number of and/or the percentage of transmission attempts that failed due to LBT blocking. A UE may update the value stored in the counter(s) after a transmission attempt fails due to LBT blocking. In an example implementation, a UE may update the value stored in the counter(s) after a configurable number of transmission attempts. In an example, the counter and/or the parameter may be reset when certain conditions are met, for example, when a timer expires, when a UE receives a specific signal from the eNB, when the counter is transmitted, when some certain conditions are met and/or when a cell is deactivated.

In an example embodiment, the UE may maintain a counter for a specific physical channel (e.g., PUSCH and PRACH). In an example, the UE may use a counter that is incremented when a transmission attempt on any of the physical channels is failed due to unsuccessful LBT.

In an example embodiment, the UE may maintain a counter for a specific physical channel (e.g., PUSCH and PRACH). In an example implementation, a UE may update the value stored in the counter(s) after a configurable number of transmission attempts.

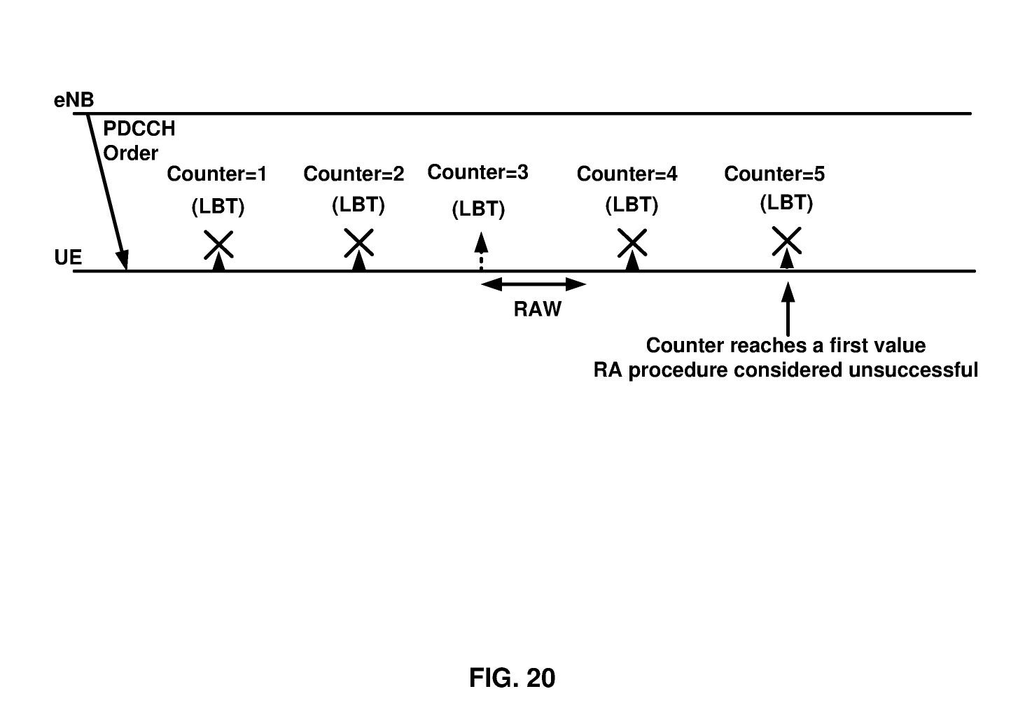

In an example, a UE may receive one or more PDCCH orders to initiate a random access procedure on an LAA cell. The UE may increment a counter after an attempt to transmit a random access preamble. The UE may consider the random access unsuccessful after the counter reaches a configured value. An example preamble transmission and counter values are shown in FIG. 20. The UE may perform an LBT for an attempt to transmit a preamble. The UE may transmit the preamble if the LBT indicates a clear channel. The UE may not transmit the preamble when LBT does not indicate a clear channel. The UE may increase the counter after a preamble transmission attempt.

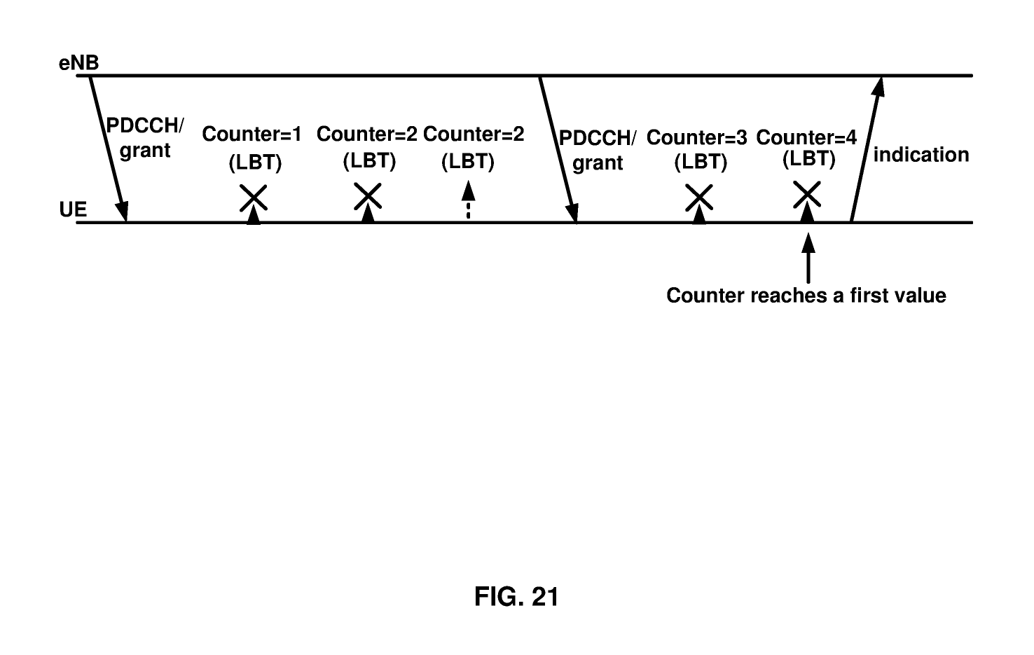

In an example, a UE may receive one or more PDCCH/grants for uplink transmission on an LAA cell. The UE may increment a counter after LBT for an uplink transmission fails. The UE may send an indication (e.g., using one or more RRC messages and/or one or MAC messages) to the eNB. The indication may depend on the value of the counter. An example is shown in FIG. 21. The UE may transmit a message to an eNB when the LBT failure counter value reaches a value (e.g. 4). The message may include information about the counter value and/or other values calculated based on one or more LBT counter values.

In an example embodiment, the UE may periodically feedback the values of the counter(s) to the eNB and/or may provide a qualitative feedback about the level of congestion on a LAA SCell (e.g., low, medium, high). The qualitative feedback may be derived based on the value stored in the counter(s) and/or other transmission statistics (e.g., traffic load, total number of transmission attempts, etc.). The feedback period may be UE specific and/or cell specific and may be configurable using one or more RRC messages. The UE may transmit the feedback to the eNB aperiodically and when certain condition is met.

In an example embodiment, an eNB may configure the UE (e.g., through RRC configuration) to send the feedback on the PUCCH on the primary cell or PUCCH SCell with a specific PUCCH format. The amount of feedback information may be small (e.g., 2 bits for qualitative congestion feedback).

In an example embodiment, an eNB may configure the UE (e.g., through RRC configuration) to transmit the feedback on PUSCH in the primary cell or one of the secondary cells.

In an example embodiment, the one or more RRC message(s) may indicate to the UE the level of detail that an eNB requires in a UE feedback (e.g., values stored in LBT counter(s) and/or qualitative feedback), the physical channel to transmit the feedback, feedback conditions, the periodicity of feedback transmission, and/or the periodicity for updating the counter(s), etc. The feedback may be transmitted in an RRC or MAC layer message.

For downlink channel access in LAA, HARQ feedback may be used for updating the contention window (CW) size. HARQ feedback may not represent the level of contention in a channel. Transmission failure may be due to high interference level and/or path loss. HARQ feedback corresponding to downlink transmissions in a single subframe may be considered for updating the contention window size in LAA. HARQ feedback corresponding to a single subframe may not capture the dynamic nature of contention level in a channel.

In an example embodiment, the UE feedback regarding LBT counter or channel congestion may be employed for updating a contention window size during the channel access procedure.

The counter value and/or congestion level feedback may be used by eNB and/or UE.

In an example embodiment, an eNB may take into account the level of congestion in an LAA carrier for uplink scheduling of LAA cells for the UE.

In an example embodiment, wherein the uplink grant may allow a UE to transmit on an LAA carrier from a set of candidate LAA carriers, the UE may choose to start the channel access procedure on channel(s) with lower level of congestion and/or lower number of failed LBT attempts based on the values stored in the counter(s). UE may perform the selection autonomously.

In an example embodiment, an eNB may take into account the level of congestion on different LAA cells, provided to eNB through the UE feedback for uplink packet scheduling and/or RACH process. The eNB may send the PDCCH order for random access on a LAA cell within a TAG with low level of congestion.

In an example embodiment, an eNB may update the PRACH configuration index for an LAA cell to a configuration with higher or lower density of PRACH resources depending on the level of congestion (provided to the eNB through the UE feedback).

According to various embodiments, a device such as, for example, a wireless device, a base station and/or the like, may comprise one or more processors and memory. The memory may store instructions that, when executed by the one or more processors, cause the device to perform a series of actions. Embodiments of example actions are illustrated in the accompanying figures and specification.

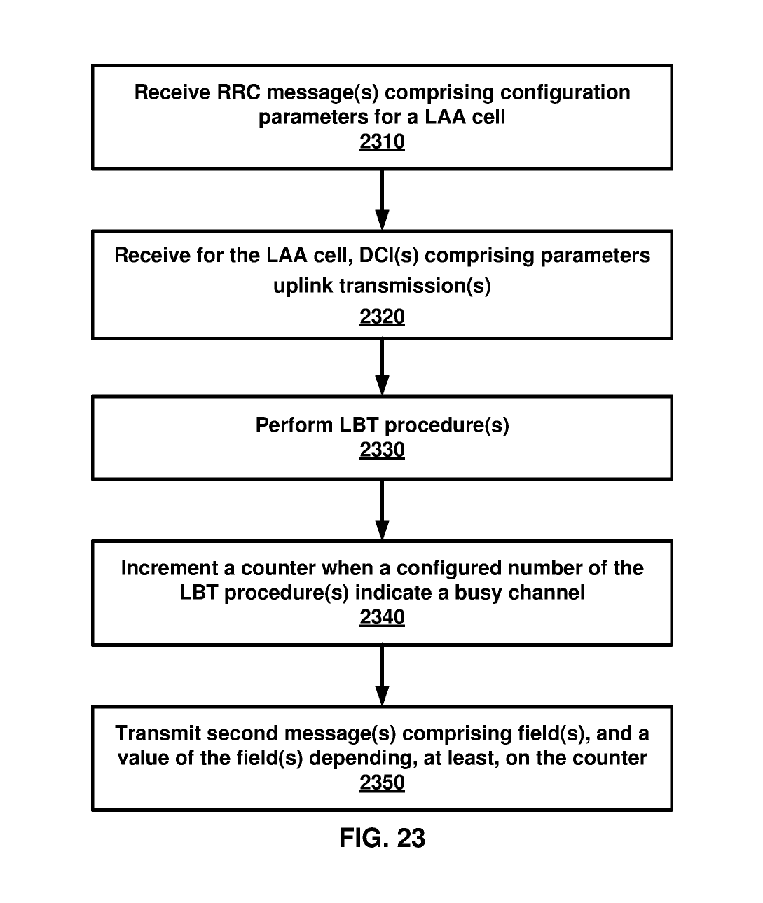

FIG. 23 is an example flow diagram as per an aspect of an embodiment of the present disclosure. At 2310, a wireless device may receive one or more first radio resource control (RRC) messages. The one or more RRC messages may comprise configuration parameters for a licensed assisted access (LAA) cell. At 2320, the wireless device may receive, for the LAA cell, one or more downlink control information (DCI) comprising parameters for one or more uplink transmissions. At 2330, the wireless device may perform one or more listen before talk (LBT) procedures. A counter may be incremented at 2340 when a configured number of the one or more LBT procedures indicate a busy channel. In an example, the configured number may be one. At 2350, the wireless device may transmit one or more second messages comprising one or more fields. A value of the one or more fields may depend, at least, on the counter.

Each of the one or more uplink transmissions may comprise, for example, one or more signals. According to an embodiment, the wireless device may further transmit one or more signals corresponding to each of the one or more uplink transmissions if the one or more LBT procedures indicates a clear channel. The configured number may be, for example, one, two or three. The value may be derived, for example, from the counter according to a pre-defined rule. The value may indicate, for example, a level of congestion on the LAA cell. At least one of the one or more second messages may be, for example, a second RRC message. At least one of the one or more second messages may be, for example, a medium access control (MAC) layer message. At least one of the one or more second messages may be, for example, a physical layer message. At least one of the one or more second messages may be, for example, transmitted periodically.

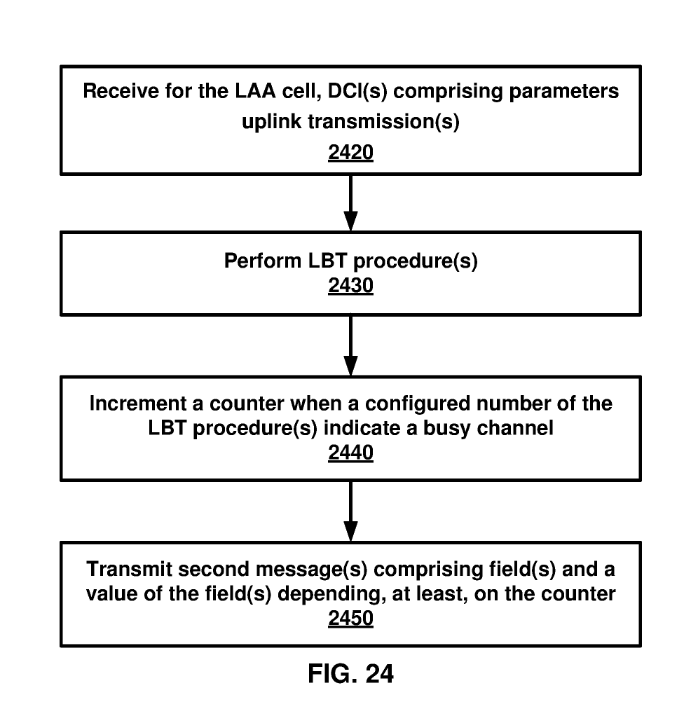

FIG. 24 is an example flow diagram as per an aspect of an embodiment of the present disclosure. At 2410, a wireless device may receive for a licensed assisted access (LAA) cell, one or more downlink control information (DCI) comprising parameters for one or more uplink transmissions. At 2420, the wireless device may perform one or more listen before talk (LBT) procedures. At 2440 a counter may be incremented when a configured number of the one or more LBT procedures indicate a busy channel. At 2450, the wireless device may transmit one or more second messages comprising one or more fields. A value of the one or more fields may depend, at least, on the counter.

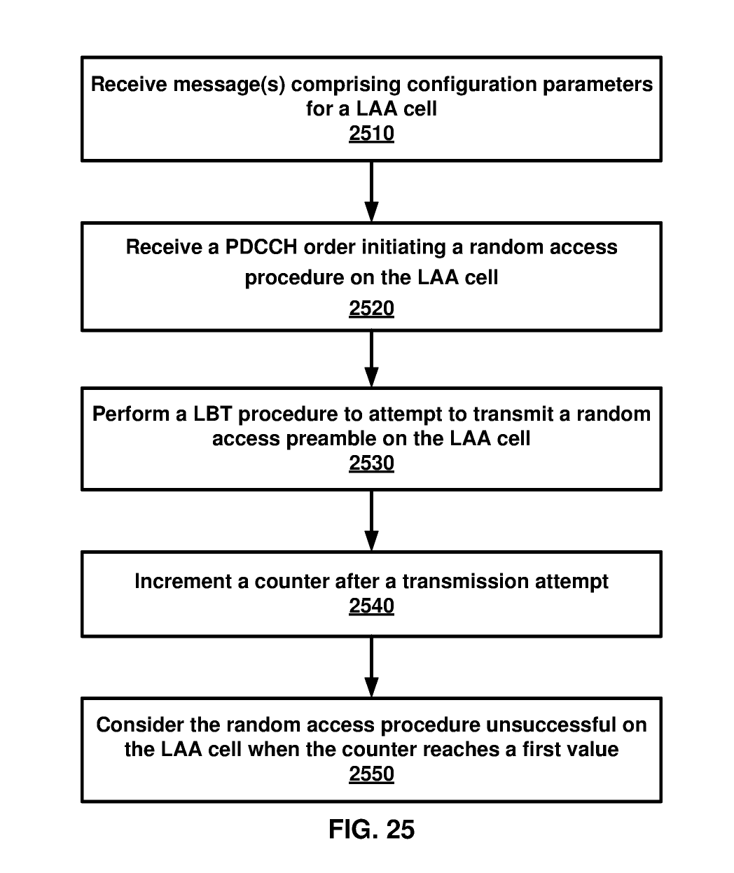

FIG. 25 is an example flow diagram as per an aspect of an embodiment of the present disclosure. At 2510, a wireless device may receive one or more messages comprising configuration parameters of a licensed assisted access (LAA) cell. At 2520, the wireless device may receive a physical downlink control channel (PDCCH) order initiating a random access procedure on the LAA cell. At 2530; the wireless device may perform a listen before talk (LBT) procedure to attempt to transmit a random access preamble on the LAA cell. A counter may be incremented at 2540 after a transmission attempt. At 2550, the wireless device may consider the random access procedure unsuccessful on the LAA cell when the counter reaches a first value.

The PDCCH order may indicate, for example, a format of the random access preamble. According to an embodiment, the wireless device may further select a format of the random access preamble. The format of the random access preamble may be, for example, Preamble Format four when the random access preamble is transmitted on a partial uplink subframe or a partial downlink subframe. The format of the random access preamble may be, for example, Preamble Format four when a number of a single carrier frequency division multiple access (SC-FDMA) is unoccupied in the partial downlink subframe or the partial uplink subframe. According to an embodiment, the wireless device may further transmit the random access preamble on a first available subframe on or after a pre-configured number of subframes after the PDCCH order is received. An available subframe may be, for example, a subframe employable for transmission of the random access preamble if the LBT procedure indicates a clear channel According to an embodiment, the wireless device may further monitor a common PDCCH to determine if a subframe is a partial subframe or a full subframe. According to an embodiment, the wireless device may further monitor a common PDCCH to determine a number of symbols in the partial subframe. According to an embodiment, the wireless device may further perform blind decoding to determine if a subframe is a partial subframe or a full subframe. The configuration parameters may comprise, for example, one or more random access configuration parameters.

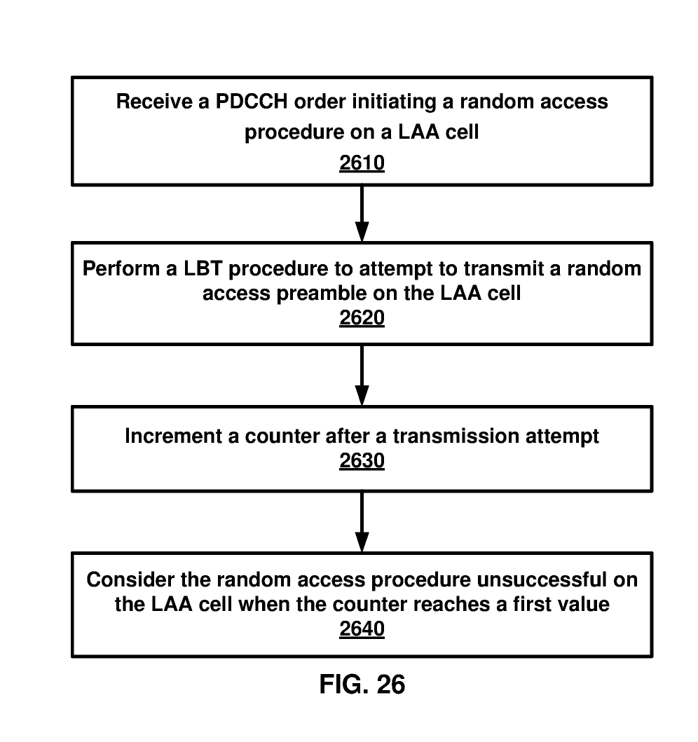

FIG. 26 is an example flow diagram as per an aspect of an embodiment of the present disclosure. At 2610, a wireless device may receive a physical downlink control channel (PDCCH) order initiating a random access procedure on a licensed assisted access (LAA) cell. At 2620, the wireless device may perform a listen before talk (LBT) procedure to attempt to transmit a random access preamble on the LAA cell. A counter may be incremented at 2630 after a transmission attempt. At 2640, the wireless device may consider the random access procedure unsuccessful on the LAA cell when the counter reaches a first value.

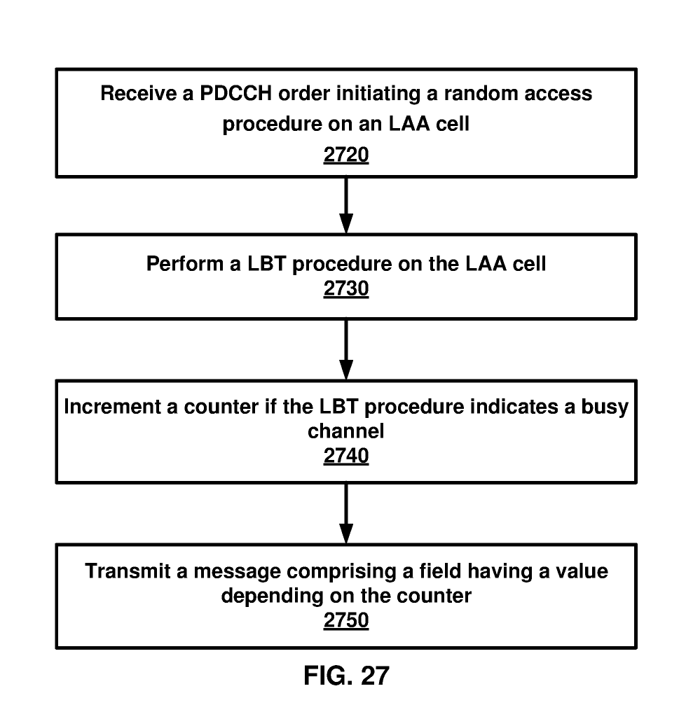

FIG. 27 is an example flow diagram as per an aspect of an embodiment of the present disclosure. At 2710, a wireless device may receive a physical downlink control channel (PDCCH) order initiating a random access procedure on a licensed assisted access (LAA) cell. At 2720, the wireless device may perform a listen before talk (LBT) procedure on the LAA cell. A counter may be incremented at 2730 if the LBT procedure indicates a busy channel. At 2740, the wireless device may transmit a message comprising a field having a value depending on the counter.

In this specification, “a” and “an” and similar phrases are to be interpreted as “at least one” and “one or more.” In this specification, the term “may” is to be interpreted as “may, for example.” In other words, the term “may” is indicative that the phrase following the term “may” is an example of one of a multitude of suitable possibilities that may, or may not, be employed to one or more of the various embodiments. If A and B are sets and every element of A is also an element of B, A is called a subset of B. In this specification, only non-empty sets and subsets are considered. For example, possible subsets of B={cell1, cell2} are: {cell1}, {cell2}, and {cell1, cell2}.

In this specification, parameters (Information elements: IEs) may comprise one or more objects, and each of those objects may comprise one or more other objects. For example, if parameter (IE) N comprises parameter (IE) M, and parameter (IE) M comprises parameter (IE) K, and parameter (IE) K comprises parameter (information element) J, then, for example, N comprises K, and N comprises J. In an example embodiment, when one or more messages comprise a plurality of parameters, it implies that a parameter in the plurality of parameters is in at least one of the one or more messages, but does not have to be in each of the one or more messages.

Many of the elements described in the disclosed embodiments may be implemented as modules. A module is defined here as an isolatable element that performs a defined function and has a defined interface to other elements. The modules described in this disclosure may be implemented in hardware, software in combination with hardware, firmware, wetware (i.e hardware with a biological element) or a combination thereof, all of which are behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. Additionally, it may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) using FDD communication systems. However, one skilled in the art will recognize that embodiments of the disclosure may also be implemented in a system comprising one or more TDD cells (e.g. frame structure 2 and/or frame structure 3-licensed assisted access). The disclosed methods and systems may be implemented in wireless or wireline systems. The features of various embodiments presented in this disclosure may be combined. One or many features (method or system) of one embodiment may be implemented in other embodiments. Only a limited number of example combinations are shown to indicate to one skilled in the art the possibility of features that may be combined in various embodiments to create enhanced transmission and reception systems and methods.

In addition, it should be understood that any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112. Claims that do not expressly include the phrase “means for” or “step for” are not to be interpreted under 35 U.S.C. 112.

What is claimed is:

1. A method comprising:
receiving, by a wireless device, one or more messages comprising configuration parameters of a licensed assisted access (LAA) cell;
receiving a physical downlink control channel (PDCCH) order initiating a random access procedure on the LAA cell;
performing a listen before talk (LBT) procedure to attempt to transmit a random access preamble on the LAA cell;
incrementing a counter after a transmission attempt; and
considering the random access procedure unsuccessful on the LAA cell when the counter reaches a first value.

2. The method of claim 1, wherein the PDCCH order indicates a format of the random access preamble.

3. The method of claim 1, further comprising selecting a format of the random access preamble.

4. The method of claim 3, wherein the format of the random access preamble is Preamble Format four when the random access preamble is transmitted on a partial uplink subframe or a partial downlink subframe.

5. The method of claim 4, wherein the format of the random access preamble is Preamble Format four when a number of a single carrier frequency division multiple access (SC-FDMA) is unoccupied in the partial downlink subframe or the partial uplink subframe.

6. The method of claim 1, further comprising transmitting the random access preamble on a first available subframe on or after a pre-configured number of subframes after the PDCCH order is received, wherein an available subframe is a subframe employable for transmission of the random access preamble if the LBT procedure indicates a clear channel.

7. The method of claim 1, further comprising monitoring a common PDCCH to determine if a subframe is a partial subframe or a full subframe.

8. The method of claim 7, further comprising monitoring a common PDCCH to determine a number of symbols in the partial subframe.

9. The method of claim 1, further comprising performing blind decoding to determine if a subframe is a partial subframe or a full subframe.

10. The method of claim 1, wherein the configuration parameters comprise one or more random access configuration parameters.

11. A wireless device comprising:
one or more processors; and
memory storing instructions that, when executed by the one or more processors, cause the wireless device to:
receive one or more messages comprising configuration parameters of a licensed assisted access (LAA) cell;
receive a physical downlink control channel (PDCCH) order initiating a random access procedure on the LAA cell;
perform a listen before talk (LBT) procedure to attempt to transmit a random access preamble on the LAA cell;
increment a counter after a transmission attempt; and
consider the random access procedure unsuccessful on the LAA cell when the counter reaches a first value.

12. The wireless device of claim 11, wherein the PDCCH order indicates a format of the random access preamble.

13. The wireless device of claim 11, wherein the instructions, when executed, further cause the wireless device to select a format of the random access preamble.

14. The wireless device of claim 13, wherein the format of the random access preamble is Preamble Format four when the random access preamble is transmitted on a partial uplink subframe or a partial downlink subframe.

15. The wireless device of claim 14, wherein the format of the random access preamble is Preamble Format four when a number of a single carrier-frequency division multiple access (SC-FDMA) is unoccupied in the partial downlink subframe or the partial uplink subframe.

16. The wireless device of claim 11, wherein the instructions, when executed, further cause the wireless device to transmit the random access preamble on a first available subframe on or after a pre-configured number of subframes after the PDCCH order is received, wherein an available subframe is a subframe employable for transmission of the random access preamble if the LBT procedure indicates a clear channel.

17. The wireless device of claim 11, wherein the instructions, when executed, further cause the wireless device to monitor a common PDCCH to determine if a subframe is a partial subframe or a full subframe.

18. The wireless device of claim 17, wherein the instructions, when executed, further cause the wireless device to monitor a common PDCCH to determine a number of symbols in the partial subframe.

19. The method of claim 11, wherein the instructions, when executed, further cause the wireless device to perform a blind decoding to determine if a subframe is a partial subframe or a full subframe.

20. The wireless device of claim 11, wherein the configuration parameters comprise one or more random access configuration parameters.
